(19) United States
(12) Patent Application Publication
(10) Pub. No.: US 2016/0342304 A1
(43) Pub. Date: Nov. 24, 2016

(54) DIMENSION-BASED DYNAMIC VISUALIZATION

(71) Applicant: Microsoft Technology Licensing, LLC, Redmond, WA (US)

(72) Inventors: Sateesh Kumar Kodavali, Fargo, ND (US); April Marie Olson, West Fargo, ND (US); Tristan Howard Cartony, West Fargo, ND (US); Andreas Robert Johan Arff, Fargo, ND (US); Jill Suzanne Carter, Reiles Acres, ND (US)

(21) Appl. No.: 14/716,350

(22) Filed: May 19, 2015

(51) Int. Cl. G06F 3/0481; G06F 3/0484

(52) U.S. Cl. CPC G06F 3/04817; G06F 3/04842

(57) ABSTRACT

A data visualization is surfaced with user input mechanisms that are actuated to change data aggregation parameters. User actuation of the user input mechanisms is detected and data is dynamically extracted from an underlying computing system and dynamically aggregated, based upon the modified aggregation parameters. A modified visualization is then generated, having a modified layout to display extracted data, aggregated based upon the modified aggregation parameters.

### BACKGROUND

Computer systems are currently in wide use. Many computer systems store or otherwise structure data that is surfaced for visualization by users.

For example, computer systems can store a wide variety of different types of data. Some of the data can represent the underlying status of the computer system itself. Other data can represent transmissions (such as electronic mail transmissions and other corresponding data such as recipients, authors, etc.). Still other computer systems can store scheduling data, such as calendar data, meeting data, and corresponding information (such as attendees, invitees, meeting organizers, the subject matter of various meetings, etc.). Still other computing systems are used by organizations in performing their operations. These types of computing systems can store aggregated data as well as metadata or other information that represents processes, workflows, entities, the organization hierarchy, etc.

Some computing systems have allowed administrators or other personnel to configure reports that can be generated in order to allow users to access the underlying data stored in the computing system. Such reports are often fixed, or they are generated from a set of static data. Such reports are often also in a predefined and fixed format for a given user to visualize desired information (such as trends, etc.). Some systems generate multiple different reports, in multiple different formats. All of the data aggregations for the different reports must be created, maintained, generated, and distributed for each different visualization of the underlying data that the user wishes to access.

The discussion above is merely provided for general background information and is not intended to be used as an aid in determining the scope of the claimed subject matter.

### SUMMARY

A data visualization is surfaced with user input mechanisms that are actuated to change data aggregation parameters. User actuation of the user input mechanisms is detected and data is dynamically extracted from an underlying computing system and dynamically aggregated, based upon the modified aggregation parameters. A modified visualization is then generated, having a modified layout to display extracted data, aggregated based upon the modified aggregation parameters.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram of one example of an interactive visualization control component, in more detail.

FIG. 3 is a block diagram of one example of an interactive visualization generation component, in more detail.

FIGS. 4A and 4B (collectively referred to herein as FIG. 4) show a flow diagram illustrating one example of the operation of a visualization system shown in FIG. 1, in generating visualizations of underlying computer system data.

FIGS. 5A-5S show various examples of user interface displays.

FIG. 6 is a block diagram showing one example of the computing system illustrated in FIG. 1, deployed in a cloud computing environment.

FIGS. 7-9 show various examples of mobile devices that can be used in the architectures shown previous figures.

FIG. 10 is a block diagram of one example of a computing environment that can be used in the architectures shown in the previous figures.

### DETAILED DESCRIPTION

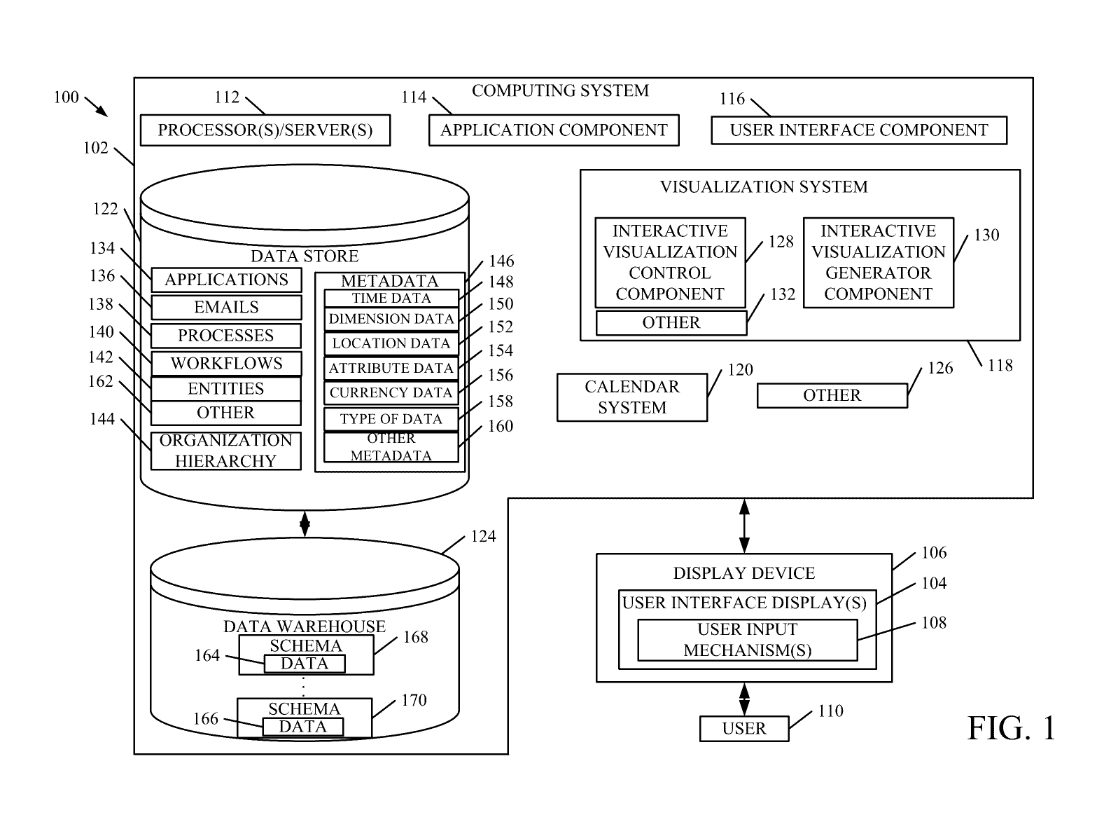

FIG. 1 shows a block diagram of one example of a computing system architecture 100. Architecture 100 illustratively includes computing system 102 that generates user interface displays 104, on display device 106. User interface displays 104 can have user input mechanisms 108 for interaction by user 110. User 110 illustratively interacts with user input mechanisms 108 in order to control and manipulate computing system 102.

In the example shown in FIG. 1, computing system 102 illustratively includes processors or servers 112, application component 114, user interface component 116, visualization system 118, calendar system 120, data store 122, data warehouse 124 (which can be part of, or separate from, data store 122), and it can include other items 126. Visualization system 118 can, itself, illustratively include interactive visualization control component 128, interactive visualization generator component 130, and it can include other items 132.

Data store 122 can include applications 134, electronic mail transmissions 136, processes 138, workflows 140, entities 142, organization hierarchy 144, metadata 146 (which, itself, can include time metadata 148, dimension metadata 150, location metadata 152, attribute metadata 154, currency metadata 156, type metadata 158, and other metadata 160), and it can include other data or records 162 as well. Data warehouse 124 can include sets of data 164 and 166 that are stored according to various schemas 168 and 170.

Before providing a more detailed description of the operation of visualization system 118, a brief overview of some of the items shown in FIG. 1, and their operation, will first be described. In one example, application component 114 runs applications 134 which can perform processes 138, workflows 140, and it can operate on entities 142 or other data records. Entities 142 can define and represent items within computing system 102, or within applications 114, or both. For instance, an electronic mail entity can represent an electronic mail message. A person entity can represent and define a person. A product entity can describe and define a product. A vendor entity can describe and define a vendor. These are only a few brief examples of the various different types of information that can be represented by entities 142.

Organization hierarchy 144 illustratively represents a hierarchy of an organization that is using computing system 102, or applications 134. For instance, it may define a hierarchy of business units, cost centers, projects, a personnel reporting structure, or a wide variety of other items that can indicate an organization structure. The various items of metadata 146 can describe different characteristics of the other data stored in data store 122. Other data 162 can include a wide variety of different types of data, depending upon the functions performed by computing system 102. For instance, it can include performance data that identifies the performance characteristics of computing system 102. Such data can include memory and processing overhead being consumed, an indication of network traffic or user traffic on computing system 102, an indication of the underlying status of various components of computing system 102, or a wide variety of other data. It can also include organization data, such as data records that indicate the performance of an organization. The data can be correlated to a wide variety of different types of parameters. For instance, it can be correlated to time (e.g., days, weeks, months, quarters, years, holidays, or other periods or corporate time intervals). It can also be correlated to different types of dimensions, to geographic location, or to a wide variety of other attributes.

Interactive visualization generator component 130 illustratively detects user interactions with user input mechanisms 108 indicating that the user wishes to visualize some of the data in data store 122 or data warehouse 124. It accesses data aggregation and visualization parameters that may be set or modified using interactive visualization control component 128, and dynamically extracts the desired information from data store 122 or warehouse 124. It then aggregates the data based on the data aggregation parameters, and defines a visualization that has a layout suitable to generate a visualization desired by user 110. It then controls user interface component 116 to display the visualization as a user interface display 104 on display device 106. It can also generate control user input mechanisms that are displayed on the display as well. Interactive visualization control component 128 illustratively detects user actuation of those control user input mechanisms and identifies modified data aggregation parameters, and controls interactive visualization generator component 130 to dynamically extract additional or different data from data store 122 or data warehouse 124, based upon the modified data aggregation parameters.

By dynamically, it is meant that an operation is taken based upon a user input, without the need for an off-line design experience or design process. For instance, where the user wishes to dynamically modify the aggregations across which data is visualized, the user simply provides a single (or a small number of) user inputs actuating user input mechanisms and the new data is automatically extracted and aggregated based upon those user inputs, without the need to redesign a report format in a separate or off-line design experience. Instead, the mechanisms are in place to automatically and dynamically extract new data and re-aggregate the data automatically, based upon those relatively few user inputs. They are also provided by the user consuming the visualization, instead of by a separate design person.

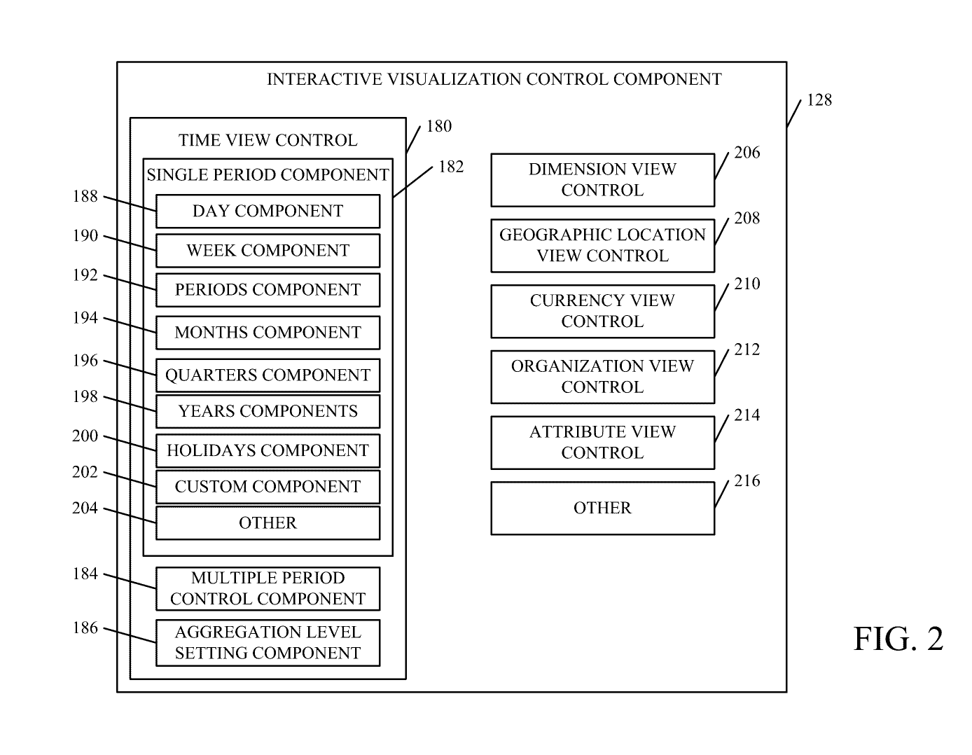

FIG. 2 is a more detailed block diagram of one example of interactive visualization control component 128. Component 128 generates user input mechanisms, and detects actuation of those user input mechanisms that are used to dynamically control the visualization of computer system data. Component 128 illustratively includes time view control 180 which can receive time, calendar, or fiscal period (or other information) from calendar system 120. Time view control 180, itself, illustratively includes single period component 182, multiple period component 184 and aggregation level setting component 186. Single period component 182 can be actuated by user 110 to visualize data correlated to a single period. For instance, component 182 can include day component 188, week component 190, other period component 192, month component 194, quarters component 196, years component 198, holidays component 200, custom component 202, and it can include other items 204. User 110 can actuate any of components 188-204 in order to set a time period over which the user wishes to observe a visualization of underlying data. Aggregation level setting 186 allows the user to set an aggregation level where the data corresponding to the various time periods is aggregated. As one example, assume that the user selects week component 190 so that the visualization shows data corresponding to individual weeks of a year. Aggregation level setting component 186 illustratively allows the user to identify a set of weeks over which the data is to be aggregated. For example, component 186 may illustratively generate a user input mechanism that allows the user to indicate that he or she wishes to also view (in addition to data broken out by week) the weekly data aggregated year-to-date.

FIG. 2 also shows that component 128 can include (in addition to time view control 180) a wide variety of other controls that allow the user to view and aggregate data according to other characteristics. For instance, component 128 can include dimension view control 206 that allows the user to view and aggregate data according to a variety of different dimensions. Geographic location view control 208 allows the user to view data correlated to geographic location. Currency view control 210 allows the user to view data correlated to various currencies. Organization view 212 allows the user to view data correlated to organizational structures or different organizational units. Attribute view control 214 allows the user to view data correlated to a variety of different attributes. Component 128 can include other items 216 as well.

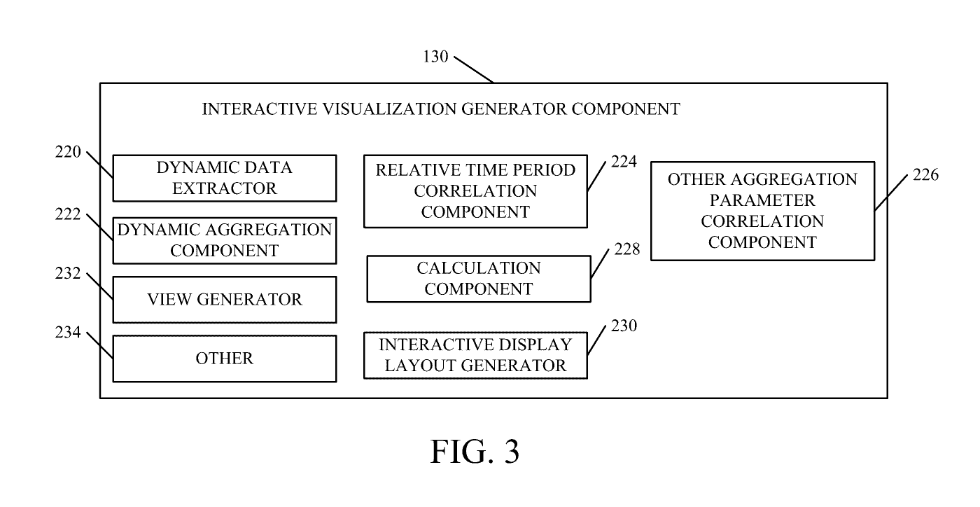

FIG. 3 is one example of a more detailed block diagram of interactive visualization generator component 130. Component 130 accesses the various parameters that are input using control component 128, and generates the visualization based upon those parameters. Component 130 thus includes dynamic data extractor 220 that dynamically extracts data given the aggregation parameters and other parameters input by the user through control component 128. Component 130 also includes dynamic aggregation component 222 that dynamically aggregates the data based upon the received parameters. Relative time period correlation component 224 illustratively allows the visualization to be generated relative to a given time period (e.g., it can generate a visualization for the “Previous” fiscal period based upon a “Current” fiscal period). This is described in greater detail below. Other aggregation parameter correlation component 226 illustratively correlates and aggregates data based upon other aggregation parameters (other than time parameters) input by the user through control component 128. Calculation component 228 illustratively performs a variety of different calculations based upon the visualization parameters.

Interactive display layout generator 230 illustratively generates a layout based upon the visualization and aggregation parameters received. For instance, if the user wishes to view data by month, for January-March, component 230 illustratively generates a layout with three different columns, one corresponding to January, one corresponding to February and one corresponding to March. On the other hand, if the user wishes to view the data by month, for an entire year, and also wishes to view the year-to-date data, then display layout generator 230 dynamically generates a new layout in which there are columns corresponding to all months of the identified year, and in which there is also a column corresponding to year-to-date. Calculation component 228 illustratively calculates the year-to-date value. View generator 232 illustratively generates the view or visualization according to the layout defined by layout generator 230 and controls user interface component 116 to display the generated view as a user interface display 104 on display device 106. Of course, interactive visualization generator component 130 can include other items 234 as well.

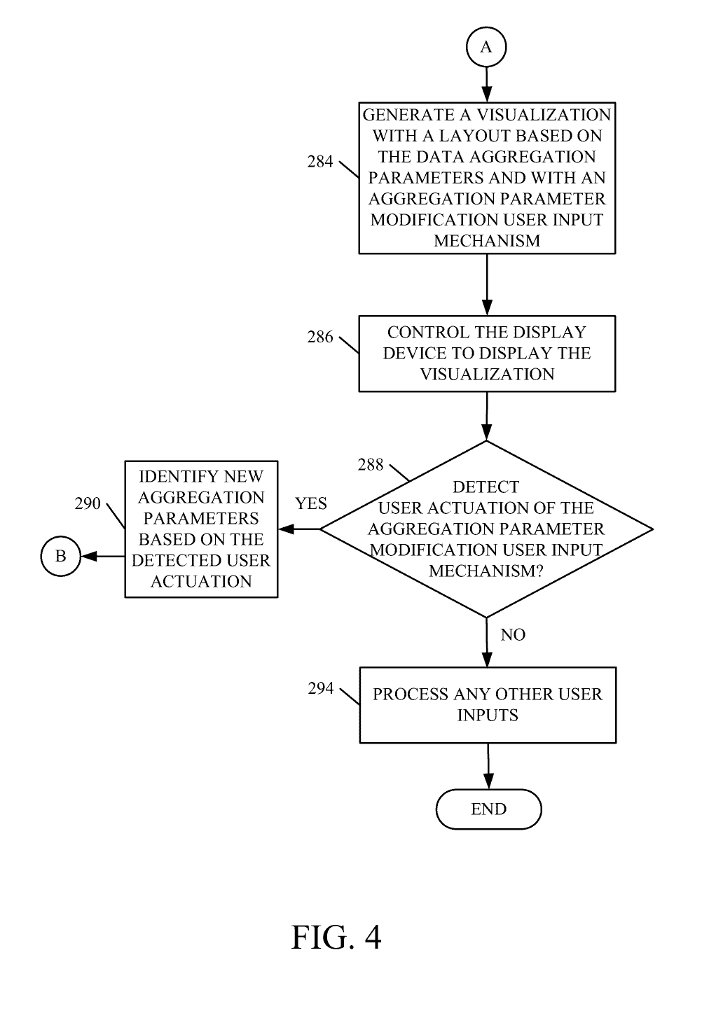

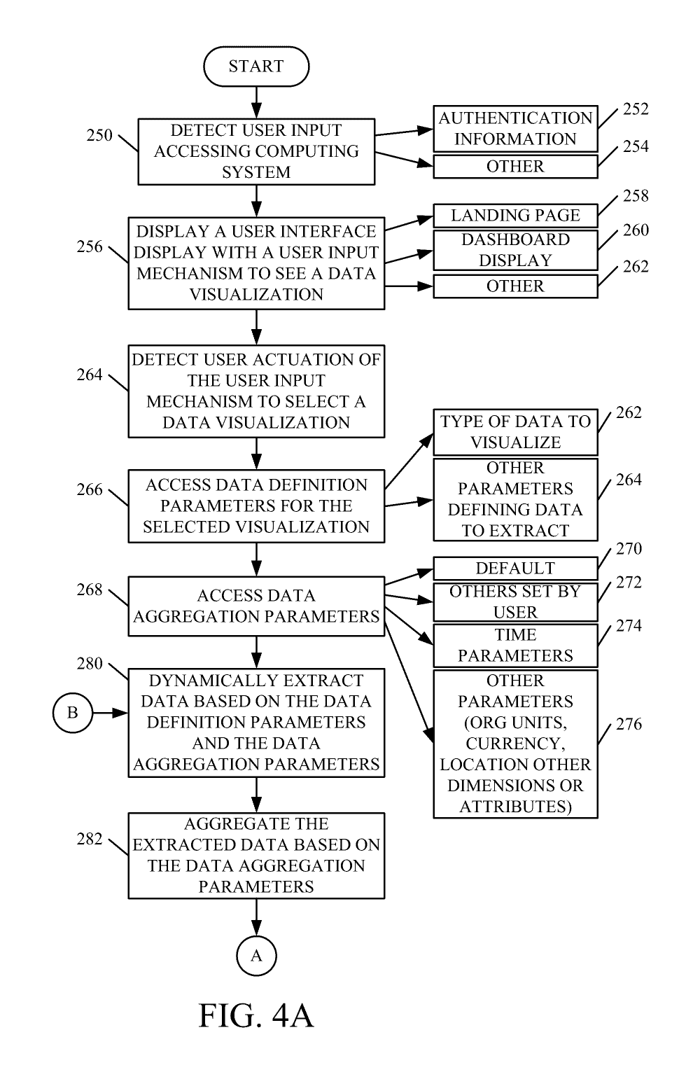

FIGS. 4A and 4B (collectively referred to herein as FIG. 4) show a flow diagram illustrating one example of the operation of visualization system 118 in generating interactive visualizations of underlying computing system data. User interface component 116 first detects a user input indicating that user 110 is accessing computing system 102. This is indicated by block 250 in FIG. 4. For instance, it can detect that user 110 is providing authentication information 252, or other information 254.

Interactive visualization generator component 130 then displays a user interface display with a user input mechanism that can be actuated by the user so that the user can see a data visualization. This is indicated by block 256. For instance, the user interface display can be landing page 258, a dashboard display 260, or a wide variety of other user interface displays 262 with user input mechanisms that user 110 can actuate in order to see a data visualization.

Interactive visualization generator component 130 then detects the user actuation of the user input mechanism to see a data visualization. This is indicated by block 264 in FIG. 4. Component 130 then accesses data definition parameters for the selected visualization. This is indicated by block 266. Those parameters can include, for instance, a type of data that is to be visualized as indicated by block 268. It can also include a wide variety of other parameters defining data to extract, as indicated by block 264. By way of example, the user may actuate a user input mechanism that indicates that the user wishes to see a set of sales data, or a set of electronic mail users, or a set of underlying computing system performance data. Based on user actuation of that user input mechanism, component 130 identifies the type of data that the user wishes to see.

Dynamic aggregation component 222 in component 130 then accesses data aggregation parameters corresponding to that visualization. This is indicated by block 268 in FIG. 4. The data aggregation parameters can be default parameters 270, other parameters that are set by the user, as indicated by block 272, time parameters 274, or a wide variety of other parameters such as currency parameters, organizational unit parameters, location parameters, or a wide variety of other dimensions or attributes as indicated by block 276. As one example, where the user wishes to see sales data, then the data aggregation default parameters 270 can correspond to a current month and a year-to-date. Thus, when the user initially actuates a user input mechanism indicating that the user wishes to see sales data, dynamic data extractor 220 extracts sales data corresponding to a current month, as well as year-to-date. Aggregation component 22 will aggregate the data for the current month and calculation component 228 will calculate an aggregation of the year-to-date data. It will be noted that components 222 and 228 can be the same components or different components. They are shown as different components in FIG. 3 for the sake of example only.

Dynamically extracting the data based upon the data definition parameters and the data aggregation parameters is indicated by block 280 the flow diagram of FIG. 4. Aggregating the extracted data based upon aggregation parameters is indicated by block 282.

Interactive display layout generator 230 then generates a visualization with a layout based upon the data aggregation parameters and with an aggregation parameter modification user input mechanism. This is indicated by block 284. For instance, and as briefly discussed above, if the default aggregation parameters are being used and those are to show sales data for a current month and year-to-date, then generator 230 illustratively generates a visualization layout that has columns corresponding to the current month and the year-to-date. It also illustratively includes a user input mechanism that can be actuated by the user in order to change the data aggregation parameters to dynamically view different data aggregations.

View generator 232 then controls user interface component 116 to display the visualization, according to the identified layout, on display device 106. This is indicated by block 286 in FIG. 4.

Any of the view control components in interactive visualization control component 128 can then detect user actuation of the aggregation parameter modification user input mechanism to dynamically modify the data aggregations in the visualization. This is indicated by block 288. If that is detected, then the corresponding view control component in component 128 identifies the new aggregation parameters based upon the detected user actuation. This is indicated by block 290. Processing then reverts back to block 280.

By way of example, assume that the user is viewing the current month's sales data and the year-to-date sales data. Assume that the user wishes to change the visualization to visualize the past three months of sales data, as well as the year-to-date data. In that case, the user may actuate the month's component 194 to reconfigure the visualization to show the most recent three months' worth of data. The time view control 180 then identifies those three months and provides them to dynamic data extractor 220 and dynamic data aggregation component 222 in component 130. Data extractor 220 then dynamically extracts the additional data from data store 122 or data warehouse 124 and dynamic aggregation component 22 illustratively aggregates the data, as desired. Layout generator 230 generates a layout including columns for the additional months, and view generator 232 controls user interface component 116 to display the modified display.

When the user no longer wishes to dynamically change the visualization, then computing system 102 can process any other user inputs. This is indicated by block 294.

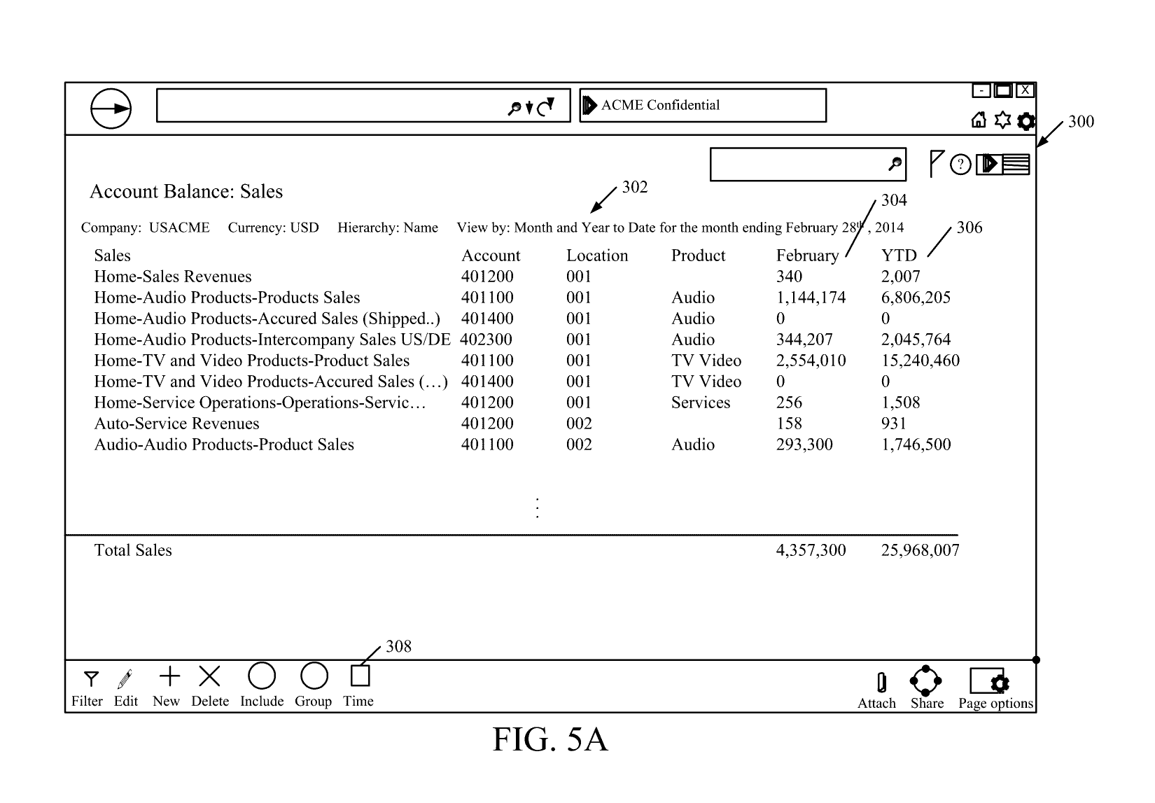

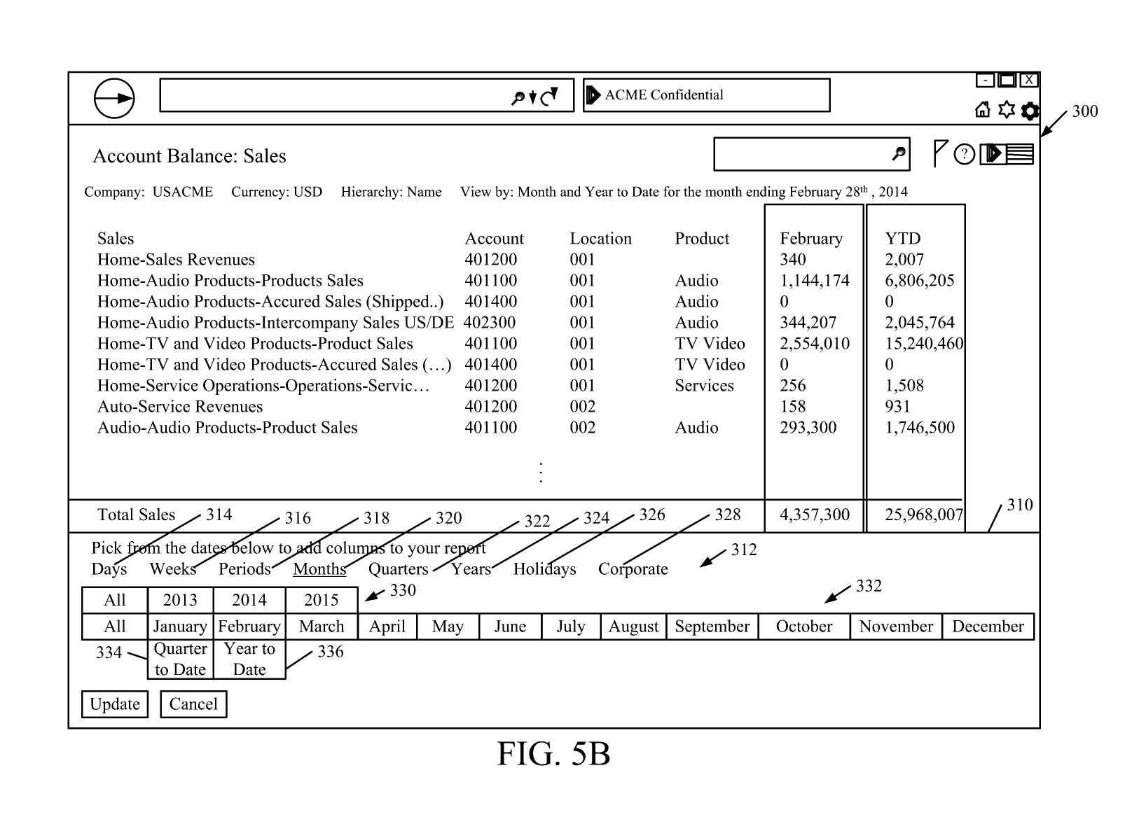

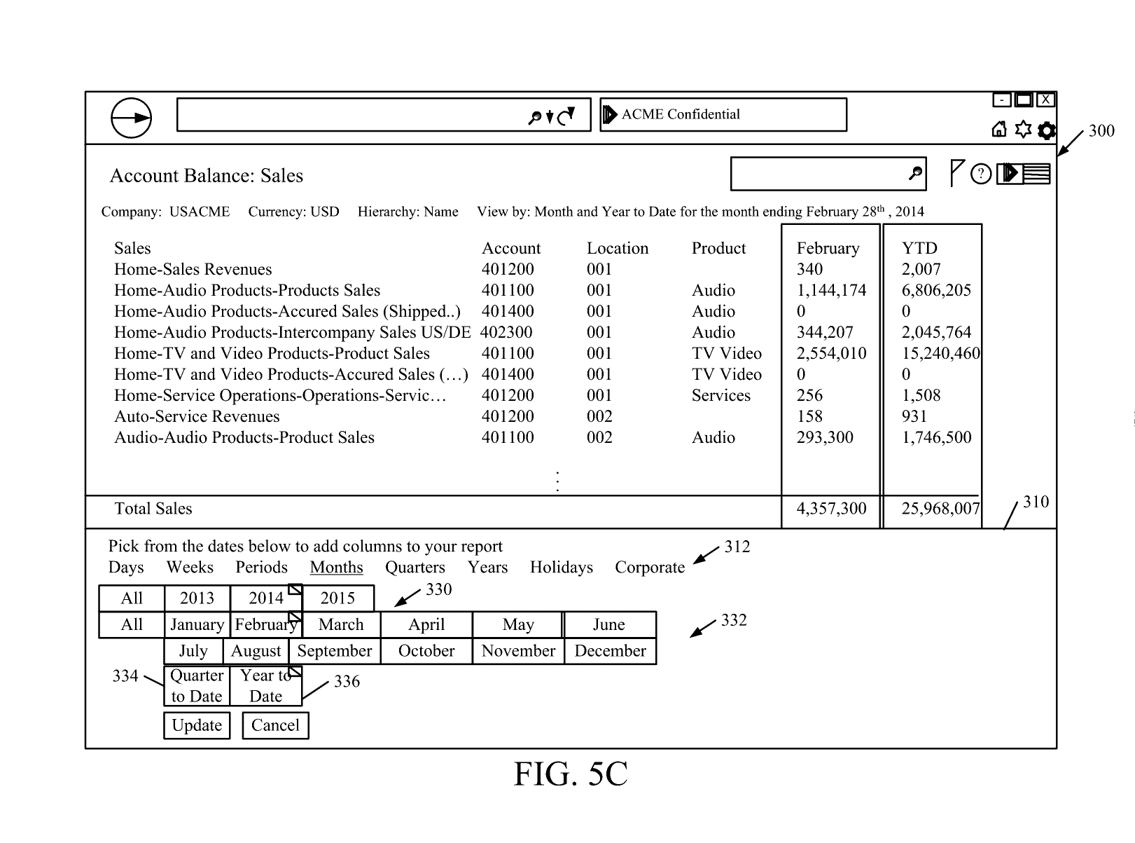

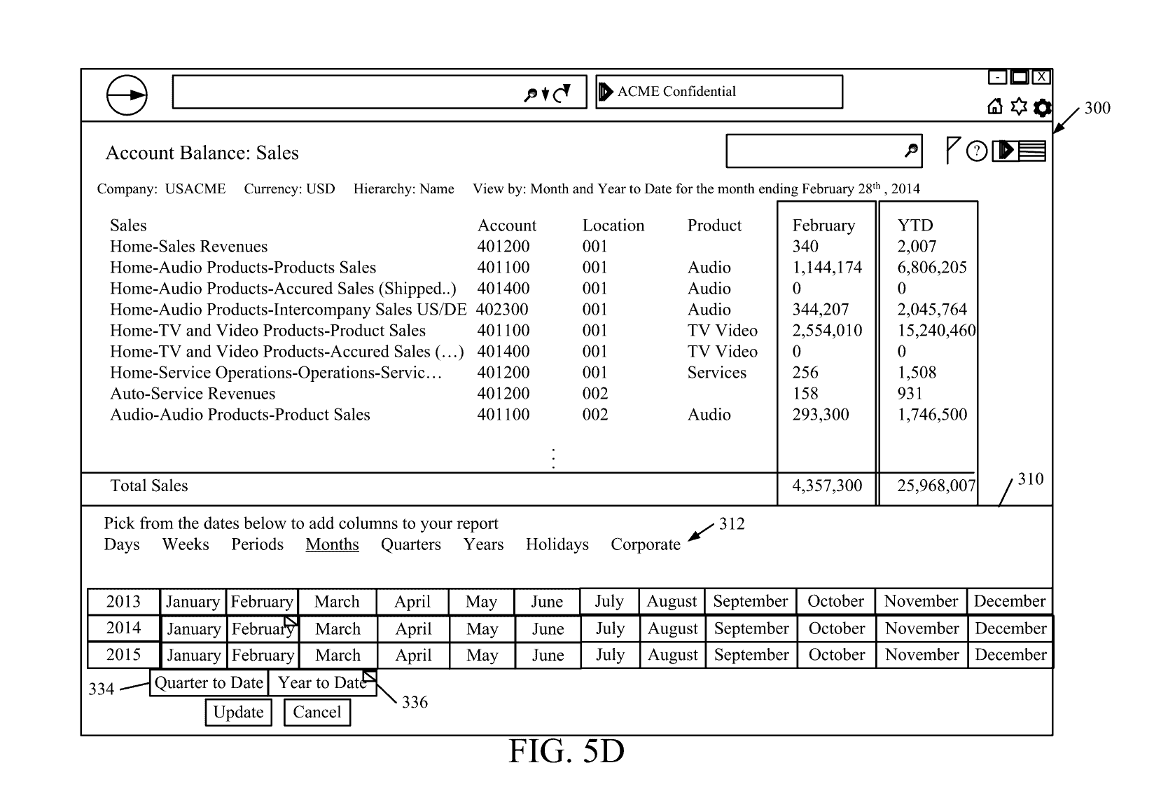

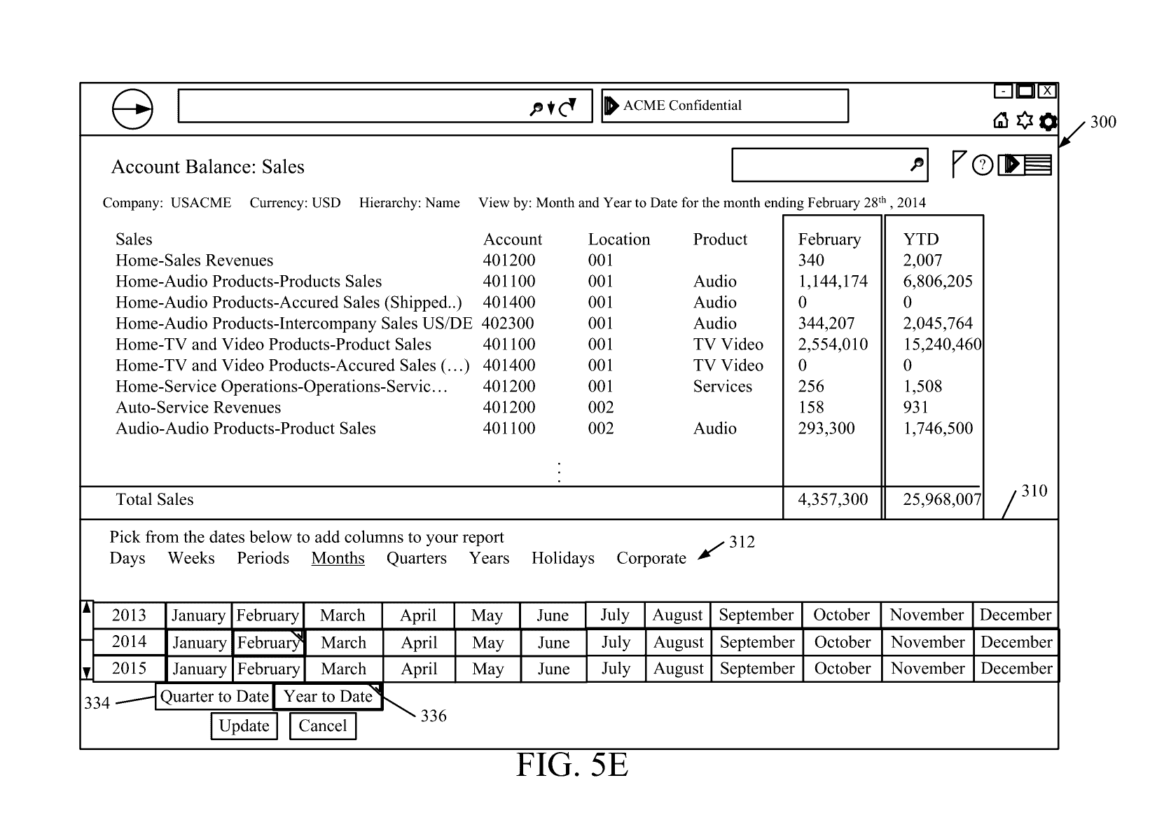

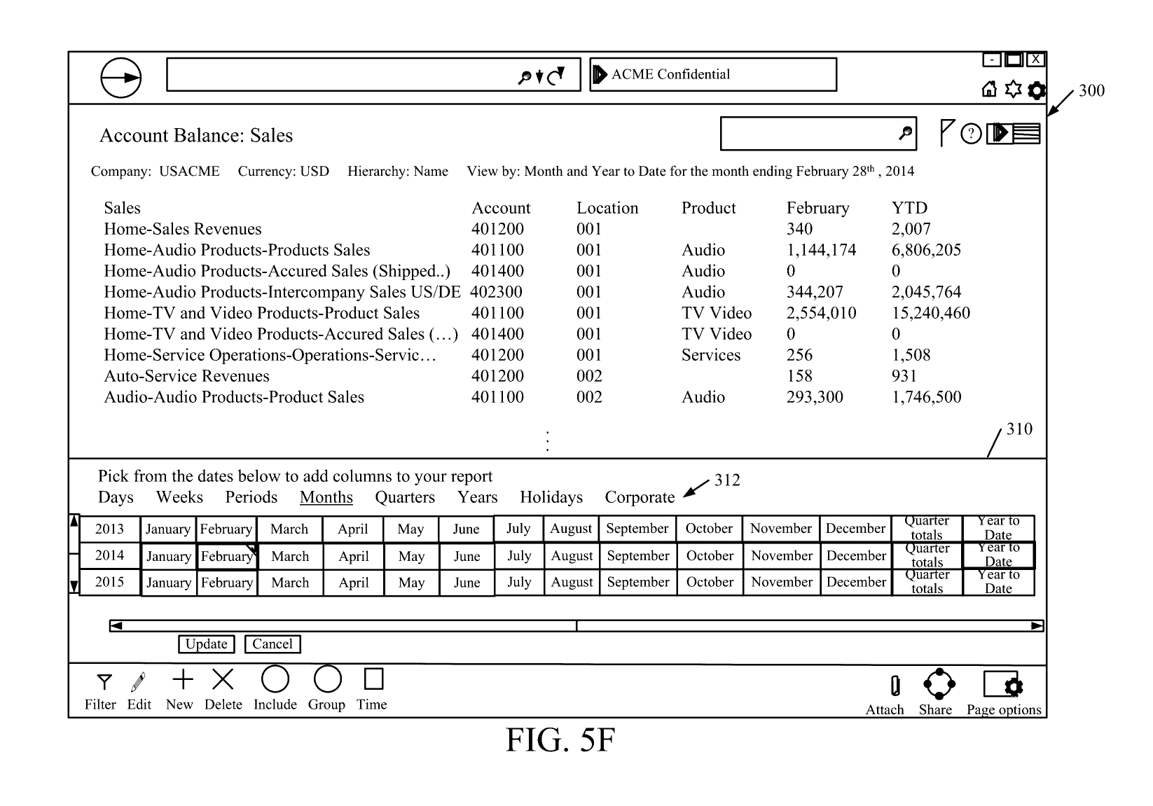

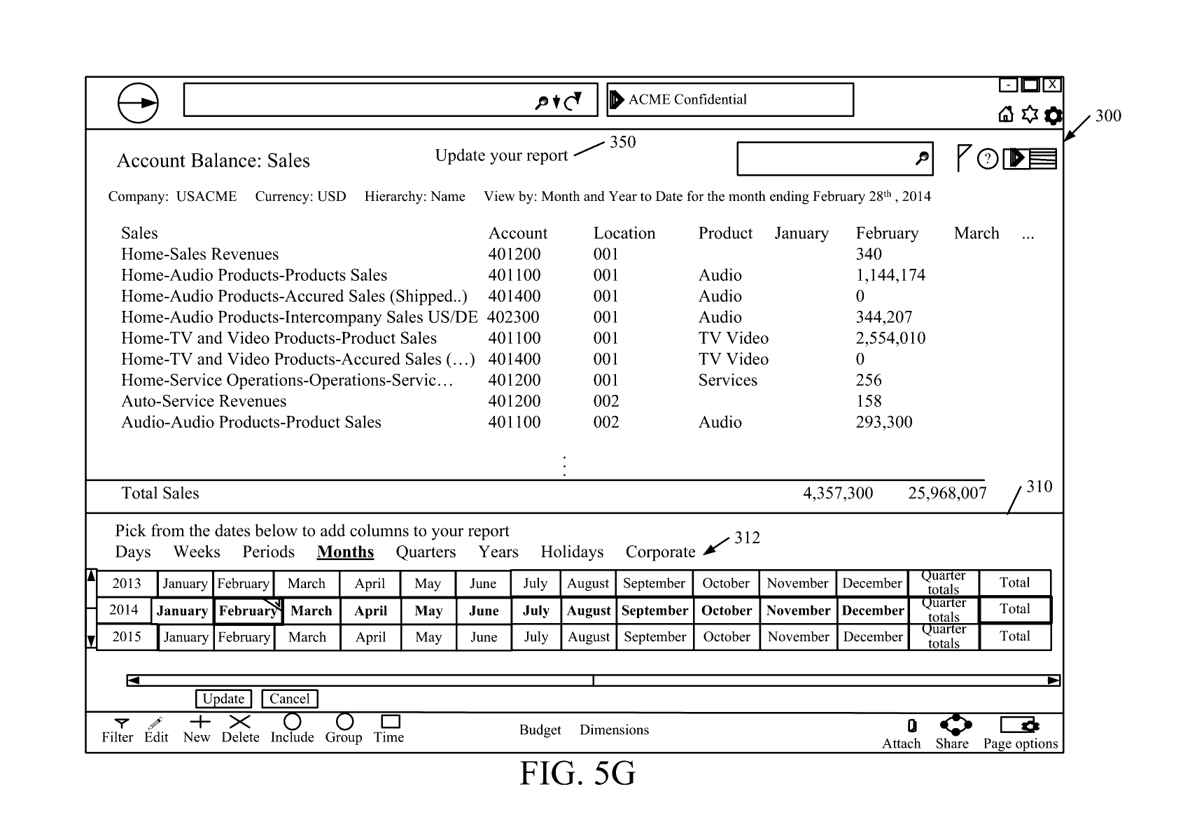

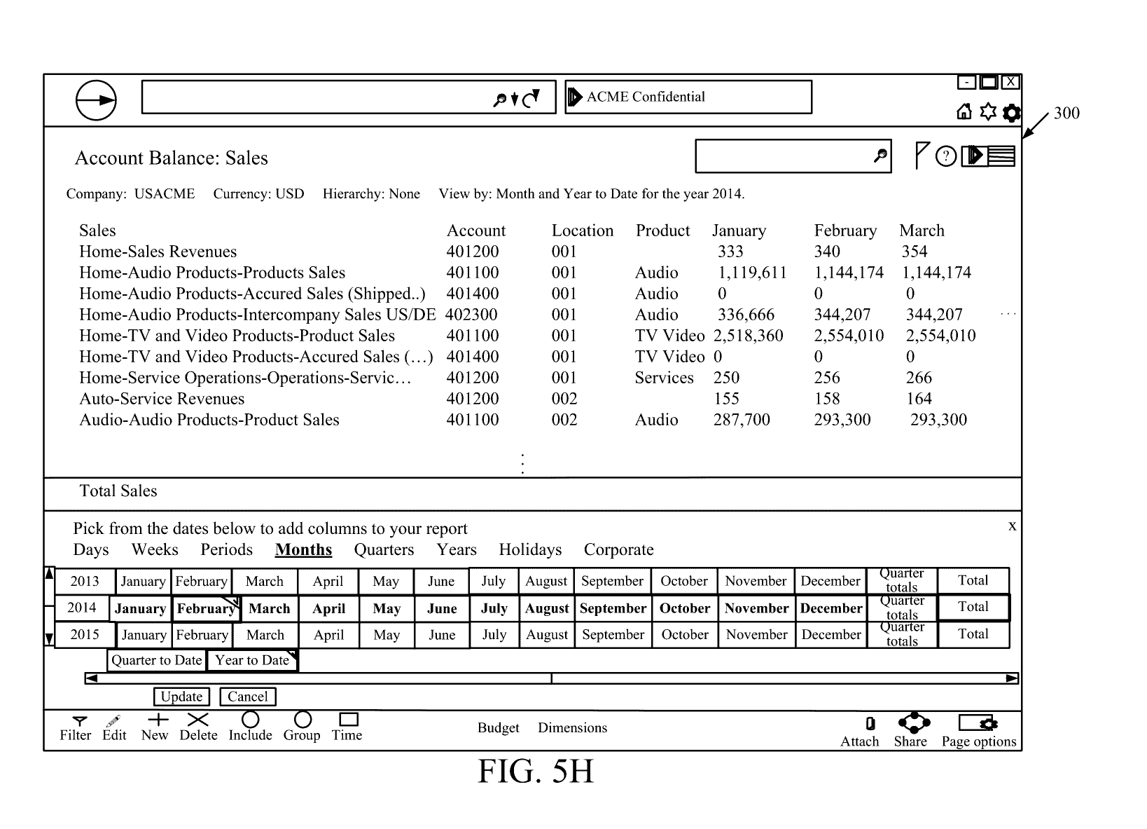

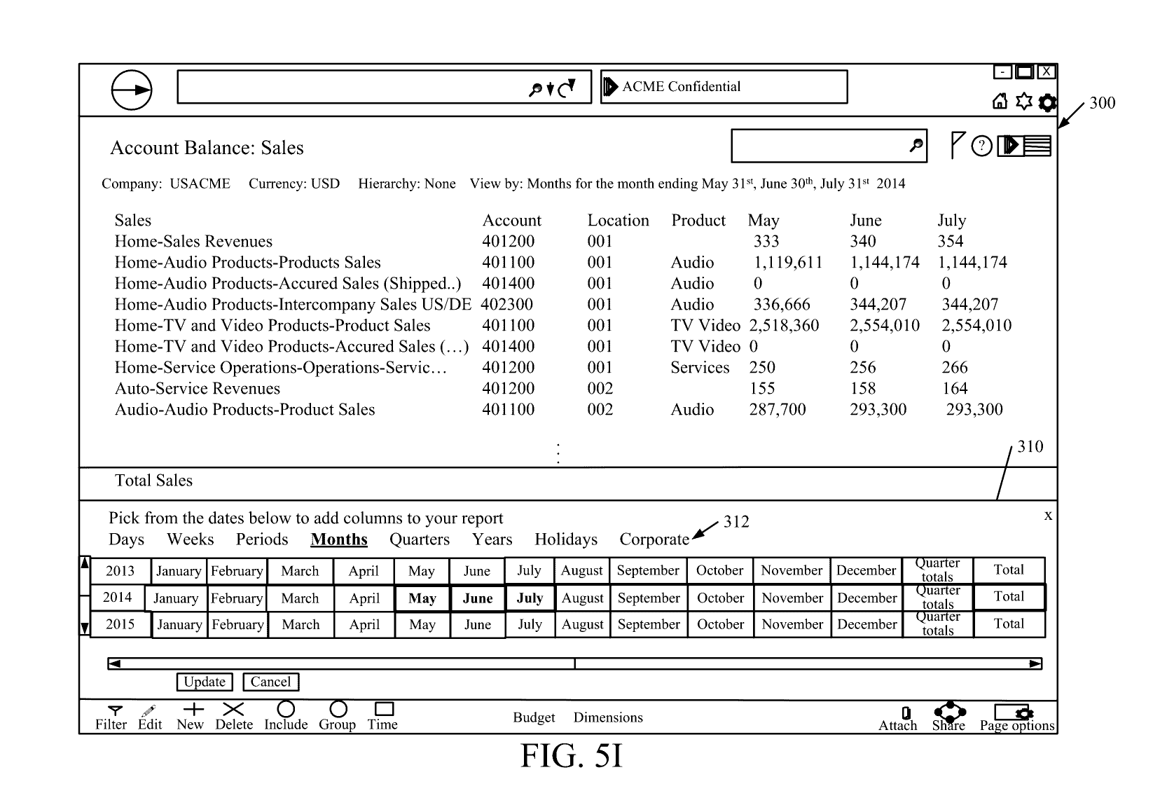

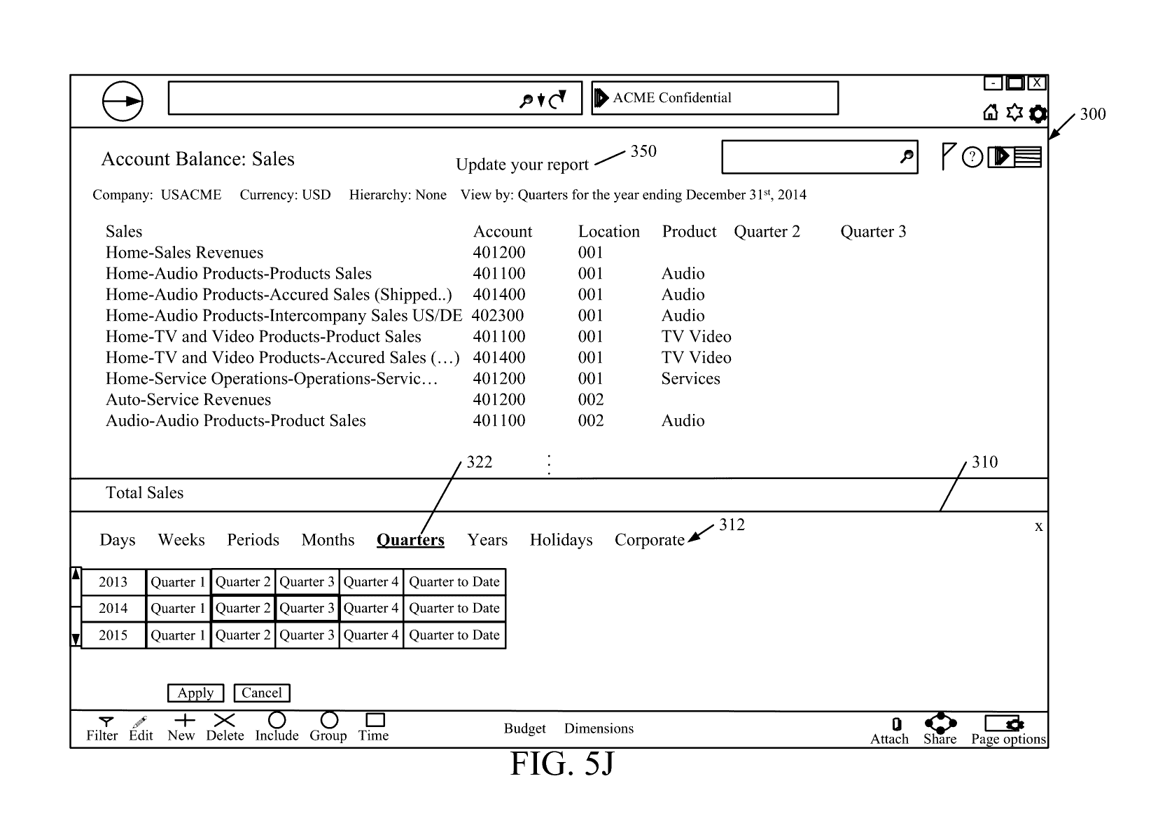

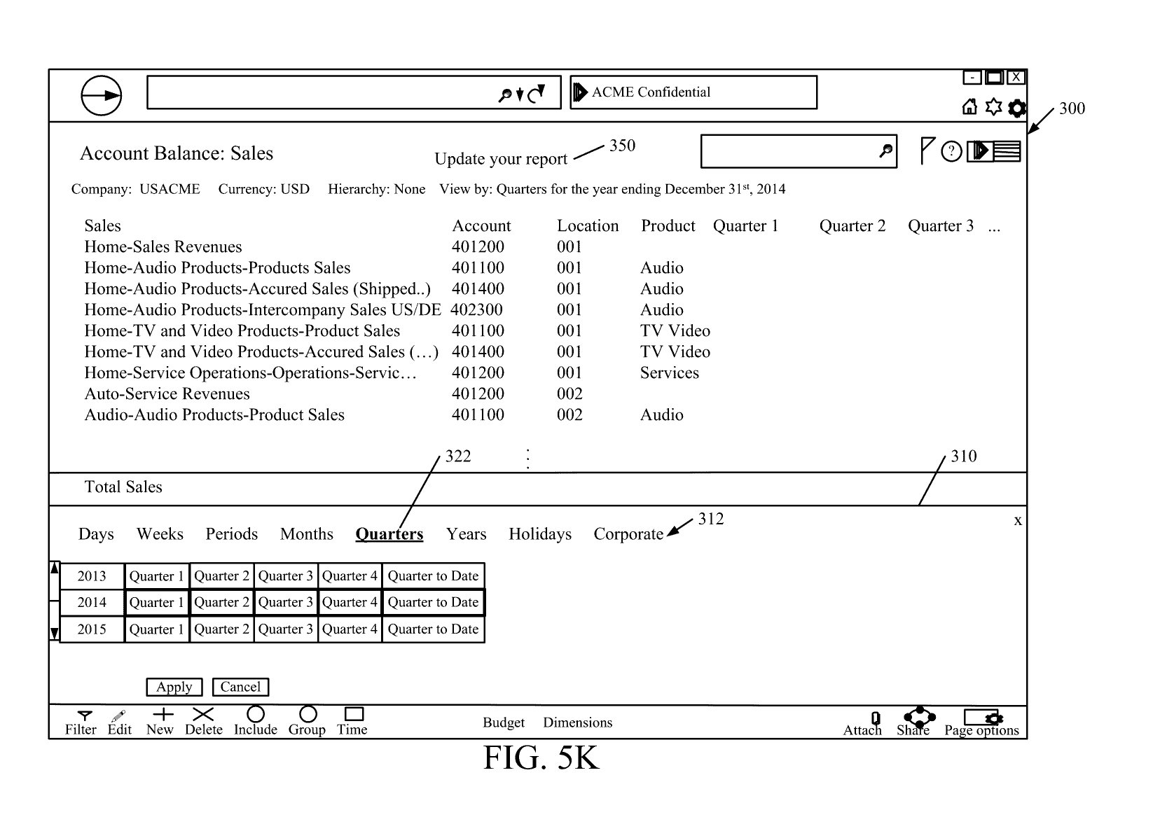

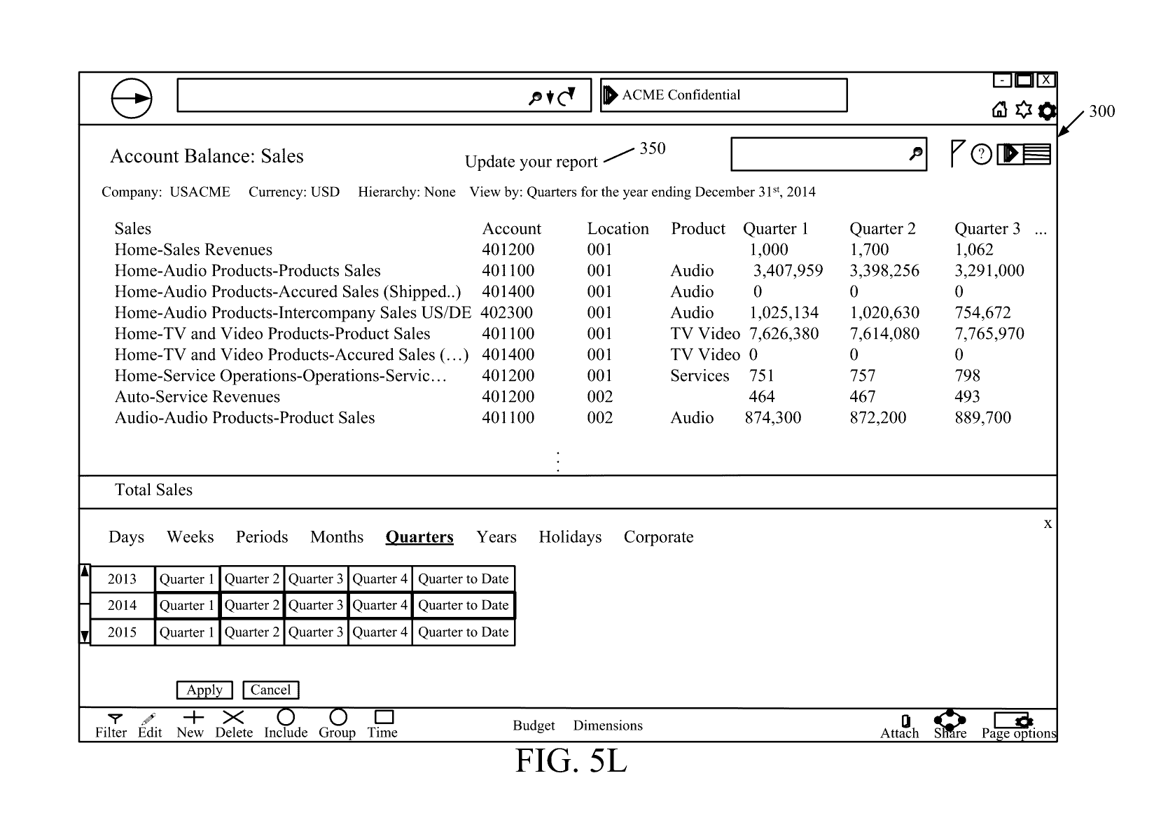

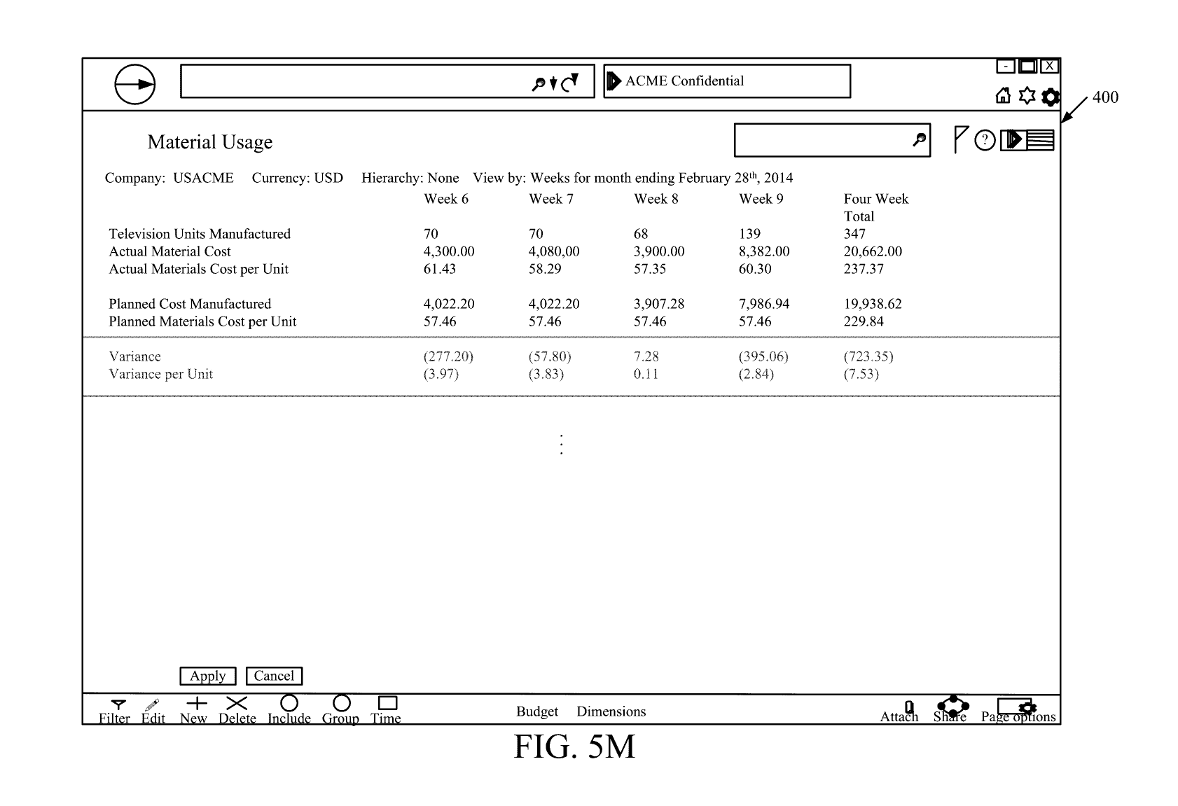

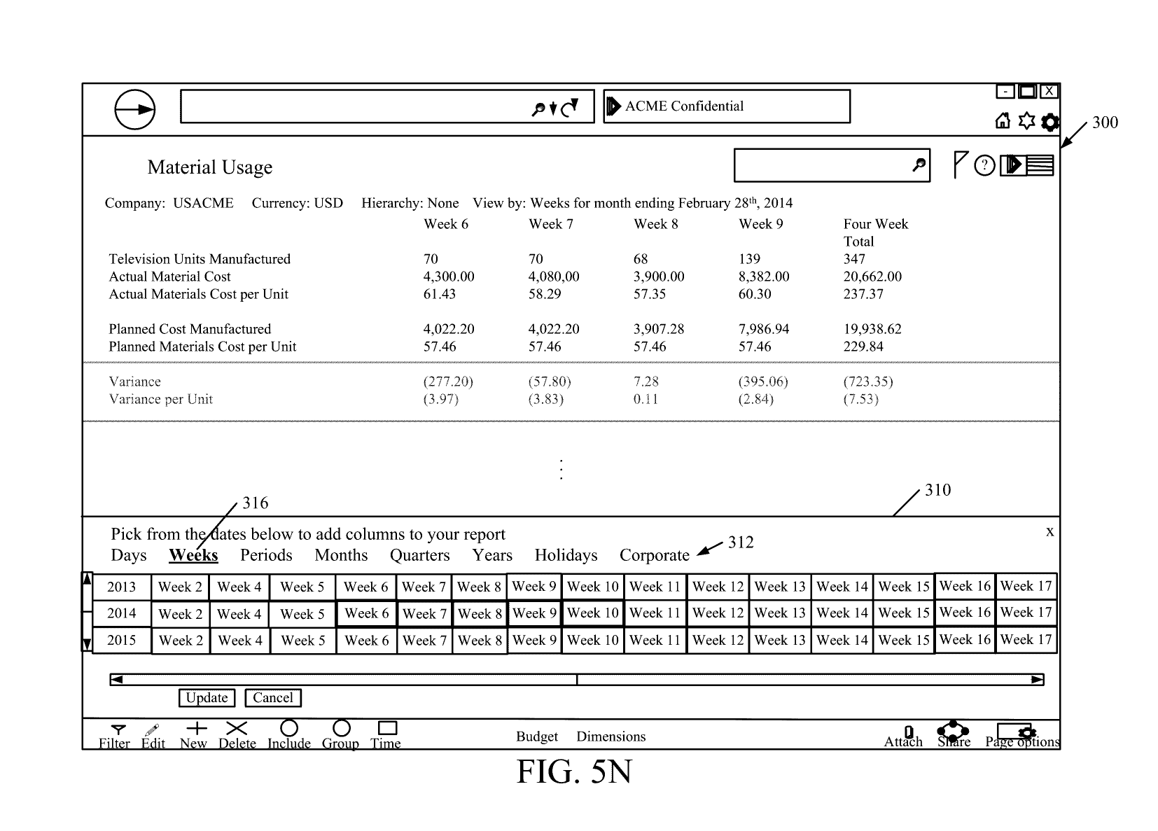

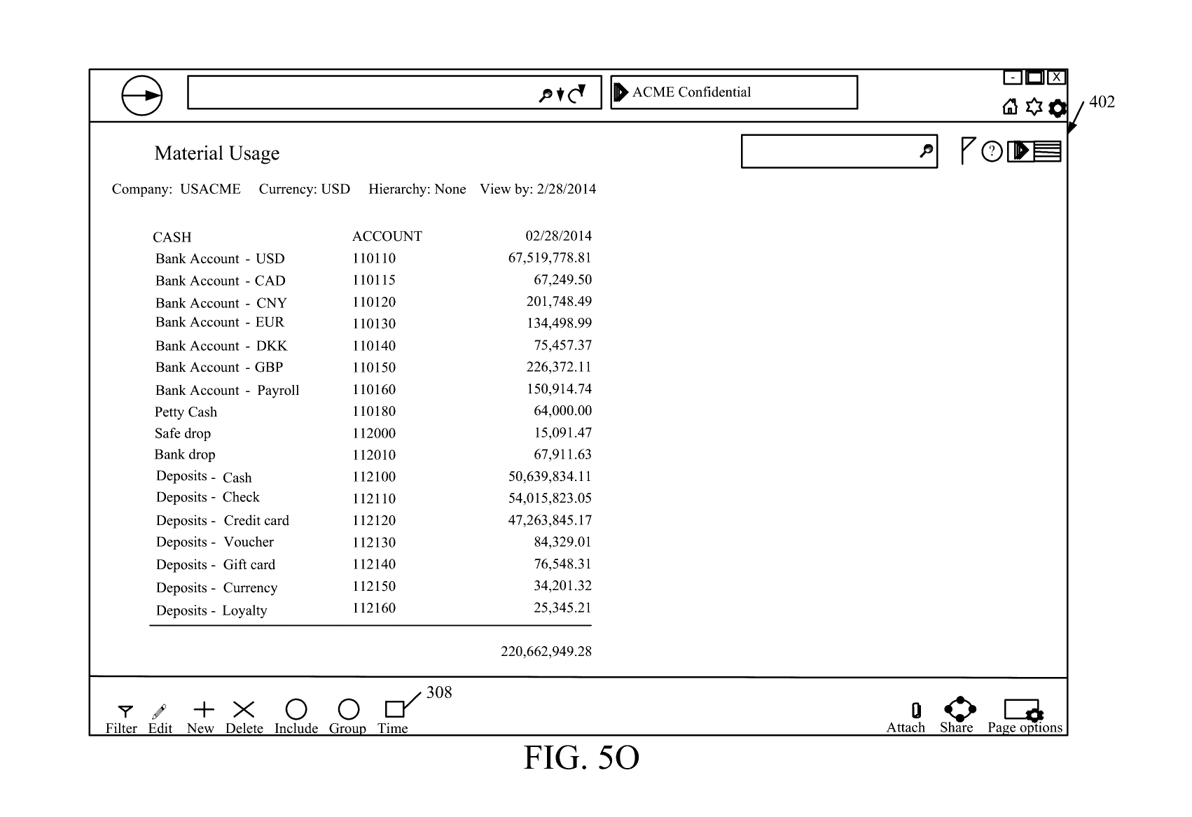

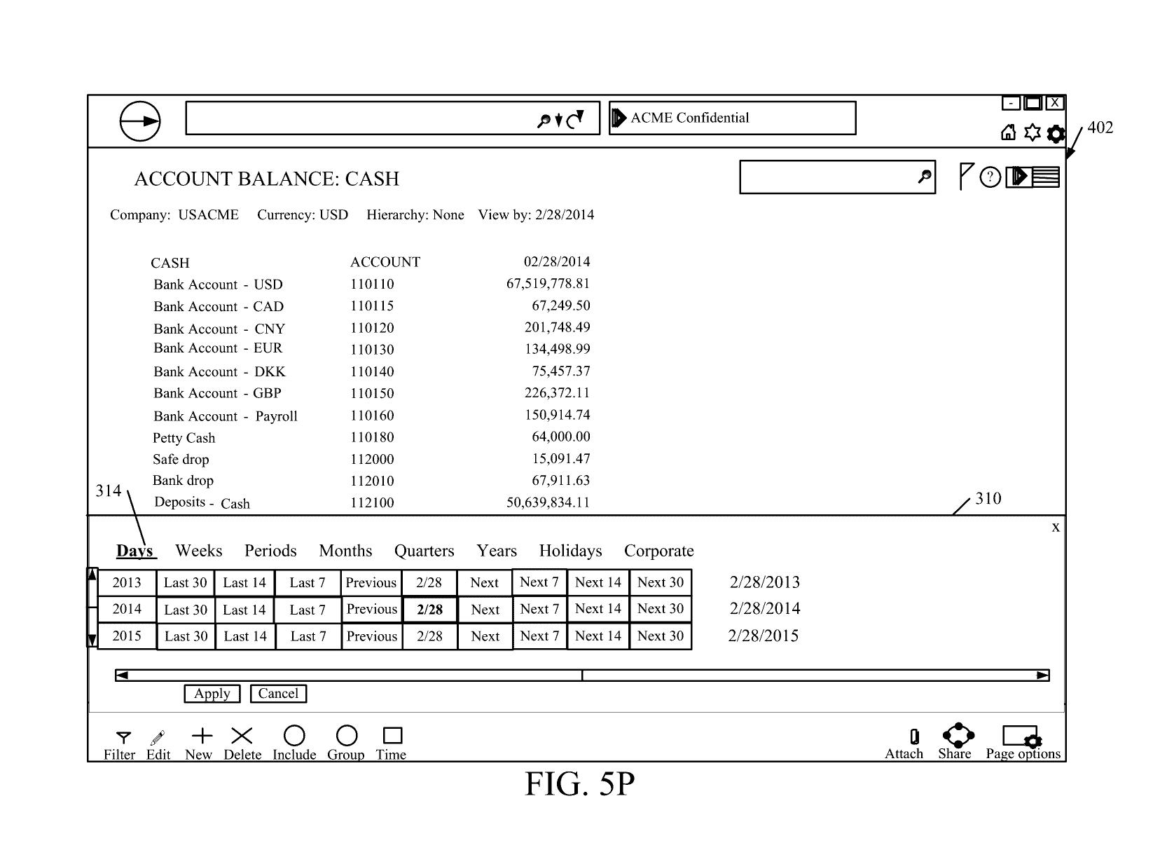

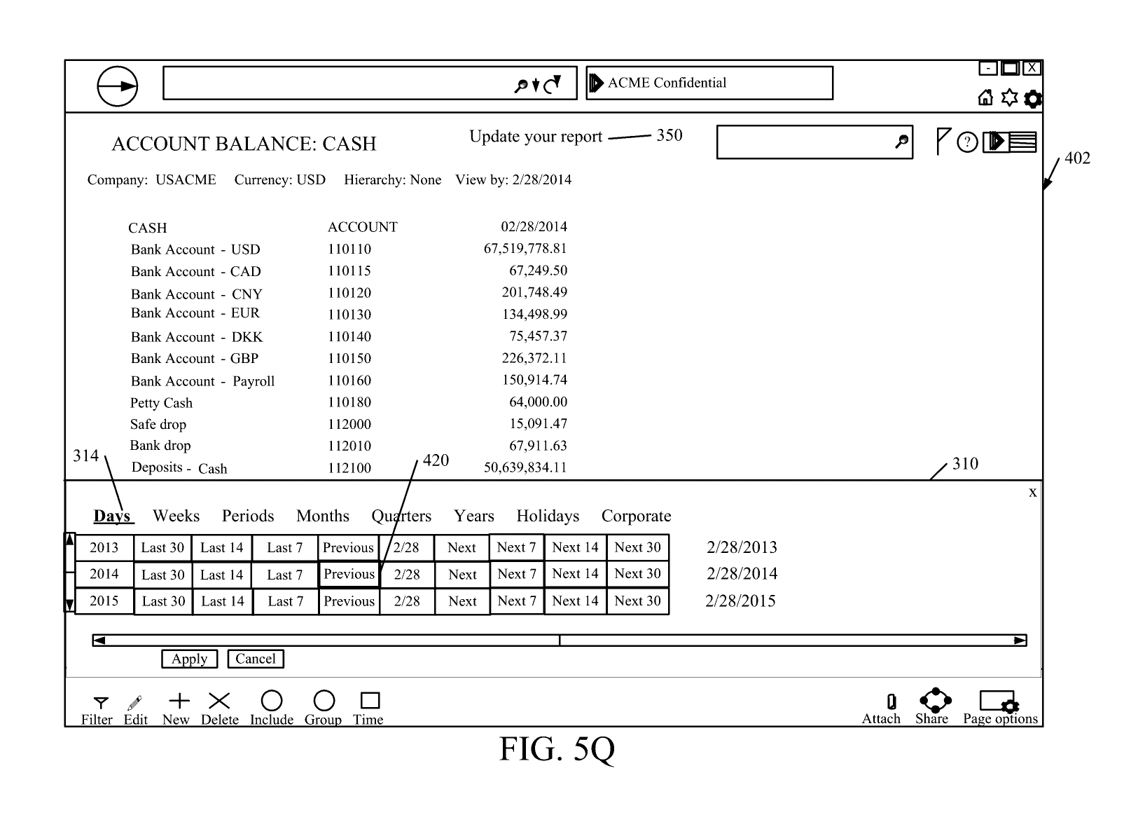

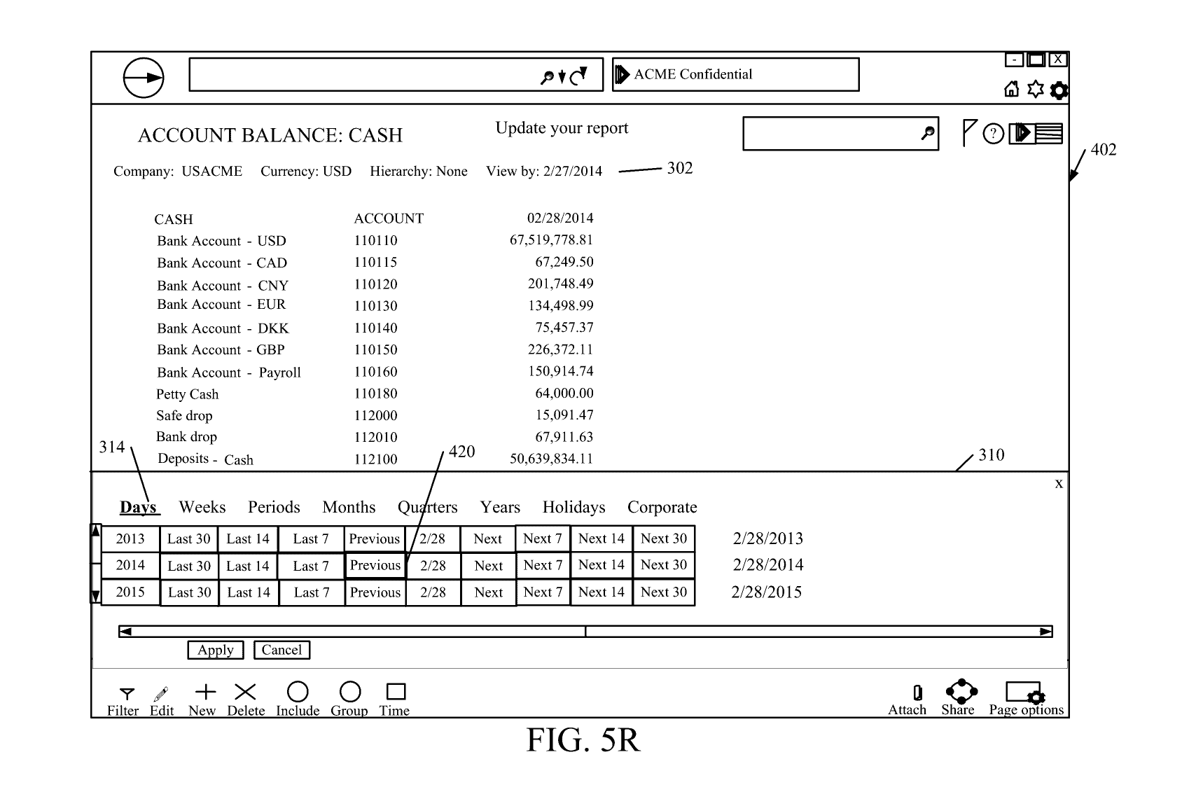

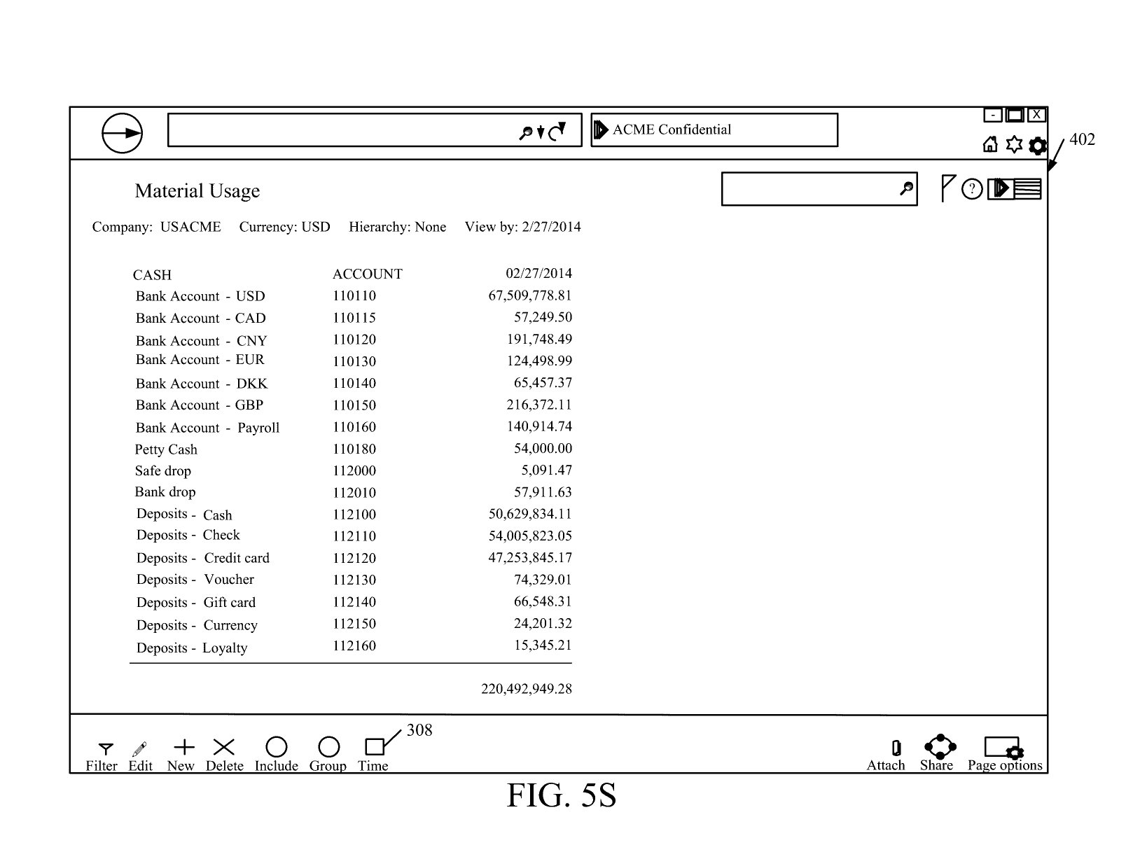

FIGS. 5A-5S show various different examples of user interface displays and corresponding controls that may help in further understanding the operation of visualization system 118. FIG. 5A shows one example of a user interface display 300 that can be generated in response to the user accessing computing system 102 and indicating that the user wishes to visualize sales data. It can be seen that user interface display 300 includes a “view by” indicator 302 that indicates that the user is viewing the sales data by month and year-to-date, for the most recent month (e.g., the month ending in February). Thus, interactive display layout generator 230 has generated a layout for user interface display 300 that includes a column 304 corresponding to the most recent complete month (e.g., February) and a column 306 showing year-to-date sales data. User interface display 300 also illustratively includes an aggregation parameter modification user input mechanism 308 that can be actuated by the user to change the data aggregation parameters used to generate user interface display 300.

FIG. 5B shows one example of user interface display 300 when the user has actuated user input mechanism 308. It can be seen that the user has actuated months user input mechanism 320. Interactive visualization control component 128 generates a set of additional time view controls that correspond to years (shown generally at 330) and months (shown generally at 332). It also illustratively generates a user input mechanism 334 corresponding to a quarter-to-date aggregation, and a user input mechanism 336 corresponding to a year-to-date aggregation. In the example shown in FIG. 5B, when the user actuates any of the user input mechanisms, this is shown by illustrating a check mark in the actuated user input mechanism. It can thus be seen that the months user input mechanism 332 corresponding to February and the year-to-date user input mechanism 336 have been actuated by the user.

FIG. 5C is similar to that shown in in FIG. 5B, except that the particular actuators on pane 310 are displayed in a different layout. The months are displayed in two horizontal rows instead of one. Also, the particular visual indicator indicating that a user input mechanism has been actuated is no longer a check mark, but instead is the visual indication that a corner of the user input mechanism has been folded over. Thus, the year user input mechanism 330 corresponding to 2014, the month user input mechanism 332 corresponding to February, and the year-to-date user input mechanism 336 visually appear as if the corners of those mechanisms have been folded down.

FIG. 5D is also similar to FIG. 5B, and similar items are similarly numbered. However, FIG. 5D now shows that all of the months for the three different years displayed (2013, 2014 and 2015) are displayed in horizontal rows. In addition, because the user has selected the “February” user input mechanism in the “2014” row, that has a visual indicator indicating that it has been selected, as does the year-to-date user input mechanism 336.

FIG. 5E is similar to FIG. 5D, and similar items are similarly numbered. However, FIG. 5E shows that the actuated user input mechanisms can be visually identified in another way as well.

FIG. 5F is also similar to FIG. 5D except that separate year-to-date actuators are now shown at the end of the horizontal rows corresponding to each year. Also, the actuated user input mechanisms are visually indicated in a different way, (such as by shading, changing the color or contrast, etc. of the selected user input mechanism).

FIG. 5G is similar to FIG. 5F, and similar items are similarly numbered. However, FIG. 5G shows that the user has now actuated all months in the horizontal row corresponding to the year 2014 and has also actuated a “total” user input mechanism corresponding to that year. Once the user has selected these items, the user can illustratively actuate the “update your report” user input mechanism 350. In that case, dynamic data extractor 220 dynamically extracts the additional data needed, and dynamic aggregation component 222 dynamically aggregates the data as well. Thus, the underlying data is not static. If the user selects a different aggregation so different underlying data is needed, it is automatically extracted.

Calculation component 228 can perform the “total” calculation or this can be performed by component 222 as well. Interactive display layout generator 230 illustratively changes the layout of the display on user interface display 300 to include columns for all of the selected years. When the user actuates “update your report” user input mechanism 350, the new data is extracted and aggregated and displayed according to the new layout.

FIG. 5H shows one example of this. It can be seen in FIG. 5 that user interface display 300 includes columns for each month in the year 2014. The display may also include a scroll bar that allows the user to horizontally scroll to see the additional columns.

FIG. 5I is similar to the previous figures, except that it shows that the user has selected the month user input mechanisms corresponding to May, June and July in the year 2014. It can thus be seen that layout generator 230 generates a new layout. Data extractor 220 and aggregation component 222 extract and aggregate the new data, and it is displayed according to that new layout.

FIG. 5J is similar to previous figures, except that it shows that the user has now actuated the “quarters” user input mechanism 322. Thus, time view control 180 generates new controls on pane 310, corresponding to quarters. FIG. 5J shows that the user has actuated the quarter user input mechanisms for the second and third quarters of the year 2014. FIG. 5J also shows that layout generator 230 has generated a new layout with two columns corresponding to the second and third quarters.

FIG. 5K is similar to FIG. 5J, except that it shows that the user has now selected all four quarter user input mechanisms corresponding to the year 2014 as well as the quarter-to-date user input mechanism. FIG. 5K also shows that layout generator 230 has modified the layout to include columns corresponding to each of the four quarters. When the user actuates the “update your report” user input mechanism 350, dynamic data extractor 220 and dynamic aggregation component 222 dynamically extract and aggregate the new data based on the quarters and display the aggregated values. One of example of this is shown in FIG. 5L.

FIG. 5M shows a different user interface display 400. Display 400 is showing “material usage” aggregated, by week, for weeks 6-9 in a given reporting period. It also shows that the data is aggregated over the four-week period. Thus, layout generator 230 has generated a layout with four columns corresponding to weeks 6-9, and a fifth column corresponding to the four-week total. FIG. 5N shows that the user has now actuated the time user input mechanism 308 so that the time view display pane 310 has now been displayed. It can be seen that the user has actuated the weeks user input mechanism 316. It can be seen that the user has also actuated the user input mechanisms for weeks 6-9 in the year 2014.

FIG. 5O shows another user interface display where the user has requested a visualization for a cash balance for a specific day (Feb. 28, 2014). FIG. 5P shows that the user has now actuated the time user input mechanism 308 so that time view control pane 310 is displayed. It can be seen that the user has actuated the days user input mechanism 314 so that pane 310 allows the user to select different days. It can also be seen that the user has selected the day Feb. 28, 2014 in the year 2014 horizontal row. Thus, interactive display layout generator 230 has generated a layout that includes a column corresponding to that day.

FIG. 5Q shows another example in which the user has selected the “day” user input mechanism 314 and has also selected a “previous” user input mechanism 420. In that case, relative time period correlation component 224 identifies the selected day as Feb. 28, 2014. It then calculates a relative offset from that date, given the user actuation of “previous” user input mechanism 420. Because the user has selected the day actuator 314, the relative time period correlation component 224 offsets the display by one day (e.g., to correspond to the previous day, Feb. 27, 2014). Interactive display layout generator 230 modifies the layout to now include a column corresponding to the day Feb. 27, 2014. When the user actuates the “update your report” user input mechanism 350, dynamic data extractor 220 and dynamic aggregation component 222 dynamically extract the new data and aggregate it, as desired.

FIG. 5R shows one example of this. It can be seen in FIG. 5R that the user interface display 402 shows cash balances in the column corresponding to Feb. 27, 2014. Having reconfigured the visualization in this way, the user can again actuate time user input mechanism 308 or “view by” user input mechanism 302 and pane 310 is no longer displayed. FIG. 5S shows one example of this. It can now be seen that the report shows the data according to the aggregation parameters dynamically input by the user. The data is dynamically extracted and the new aggregations are dynamically generated.

It can thus be seen that the present system allows a user to dynamically change a visualization layout, without the normal manual intervention needed to completely reconfigure a static report. Instead, this can be done by the consumer of the visualization. The time view control 180 illustratively generates pane 310 so that the user can easily and quickly modify the data aggregation parameters that define the particular aggregation periods over which the user wishes to view the data. Of course, where other data aggregation parameters (such as dimensions, geographic location, currency, organization units, or other attributes or characteristics) are selected by the user, the data corresponding to those aggregation parameters is also dynamically extracted and aggregated and then surfaced as a visualization for the user.

The layout of the visualization is also dynamically modified to include display elements (e.g., columns, bars in a bar chart, etc.) that have a type and a number that show the aggregations requested by the user, without needing to redesign a visualization. Instead, it is simply dynamically updated according to the aggregation parameters input by the user.

Further, the relative time period correlation component 224 can automatically trigger off of a current period (or a currently selected period) so that the user can simply select relative offsets from that period, and the system automatically extracts and aggregates the data based upon that relative offset. For example, assume that the user has selected the month mechanism 320 and a currently selected period is the month of February, but the user wishes to review March and April data instead. The month of February can advantageously be interpreted by relative time period correlation component 224 as a current period so that March and April are viewed as the current period plus a relative offset of one month and the current period plus a relative offset two months, respectively. Then, when the month of March becomes the current period through the natural passage of time, April becomes the value of the current period plus one month and May becomes the value of the current period plus two months, etc. Aggregations and calculations can be maintained in related views as the data changes, based on changes in the time view.

It will also be noted that, in one example, multiple users can advantageously change the time (or other attribute) view at the same time for the same visualization, without being aware of each other's change In that case, interactive visualization generator component 130 and an interactive visualization control component 128 can have multiple instances serving the different users.

In addition, time view control pane 310 includes a wide variety of user input mechanisms that can be used to aggregate data. Instead of simply having day, month and year user input mechanisms, it also provides a user input mechanism that supports the concept of a fiscal period that will vary with the actual calendar date and fiscal calendar in use. Interactive visualization generator component 130 illustratively uses the conceptual current fiscal period to generate visualizations that change dynamically over time, by having rows or columns (or other display elements) in the visualization that bind to the current period. Control component 128 illustratively allows the user to change the period that the visualization was generated for to any period in a known fiscal calendar, to multiple periods in the fiscal calendar, or to representations of time that are different from fiscal periods. The fiscal periods may include such things as fiscal quarters, fiscal years, calendar days, calendar weeks, dog years, calendar months, etc. However, the user input mechanisms can also correspond to customized periods that may be important to an organization. For instance, they can have a period corresponding to “Black Friday”, game days where the organization provides sports-related services, key dates or date ranges as defined by the organization, etc.

In addition, when the user selects multiple periods instead of a current period, the area of the user interface display that generates a visualization of that data changes to include data for the selected multiple periods. As the user manipulates the time view control 180, data bound to the current period reflects the changes that the user provides. As the user alters time view selections, modifications can be made in relation to a current period, allowing the report to change as time passes, without any further user inputs.

This improves the operation of the computing system 102, itself. Instead of needing to pre-process, create, and maintain separate reports for a plurality of individual users, those users can dynamically obtain their own desired visualizations. It also drastically improves the efficiency of the user, because the user need not manually extract information from a plurality of different reports, in order to observe such things as trends. Instead, the user can set time periods, or other attributes, over which data is to be aggregated and substantially immediately view that data. This reduces the number of reports that a user needs and greatly enhances the ability of the user to identify data through these visualizations.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

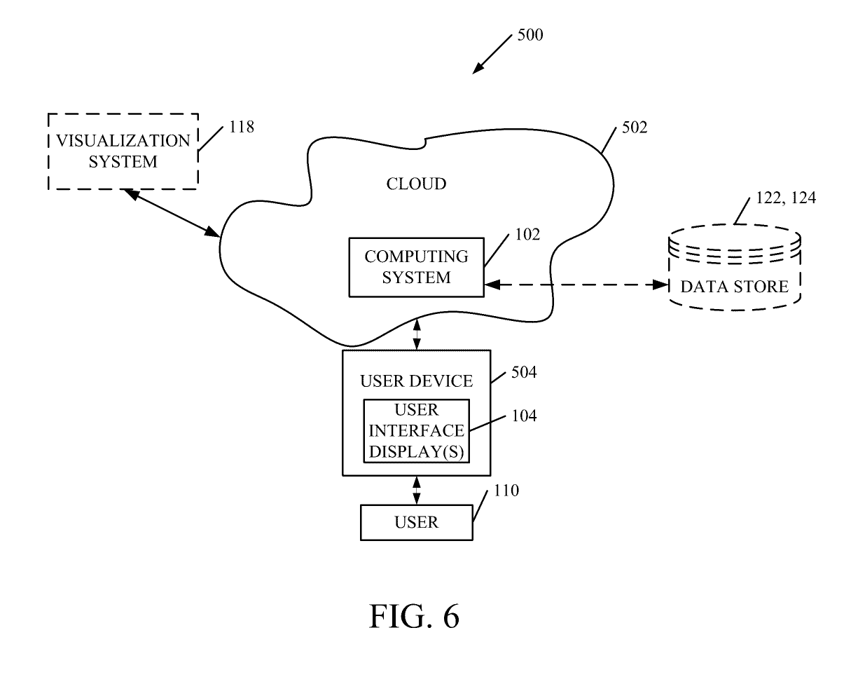

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that computing system 102 can be located in cloud 502 (which can be public, private, or a combination where portions are public while others are private). Therefore, user 110 uses a user device 504 to access those systems through cloud 502.

FIG. 6 also depicts another example of a cloud architecture. FIG. 6 shows that it is also contemplated that some elements of computing system 102 can be disposed in cloud 502 while others are not. By way of example, data stores 122, 124 can be disposed outside of cloud 502, and accessed through cloud 502. In another example, visualization system 118 can be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

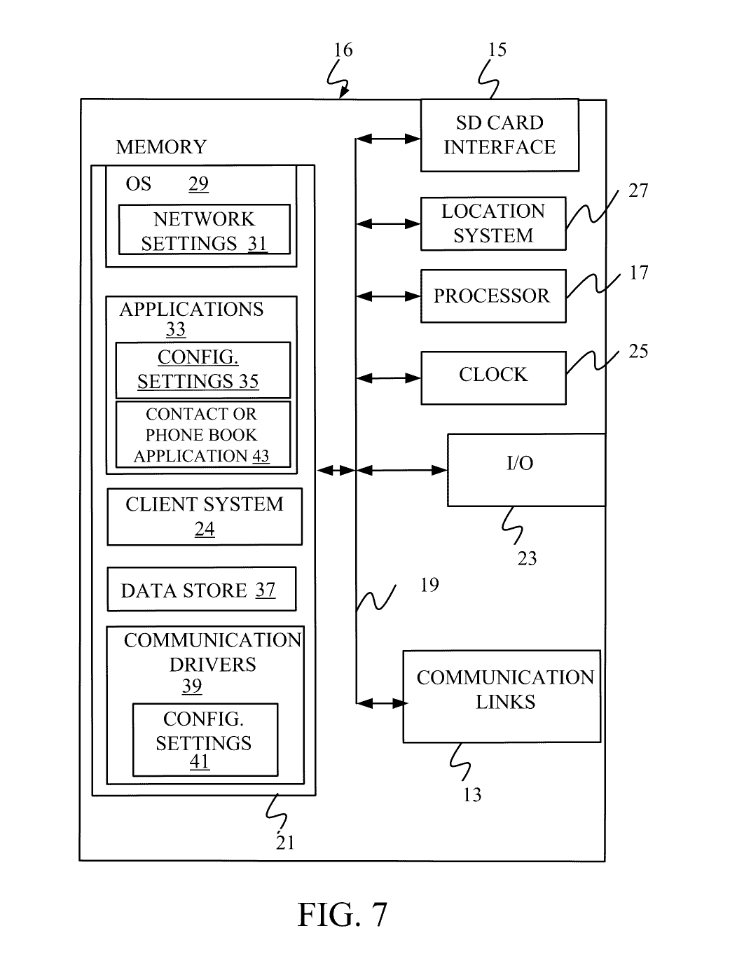

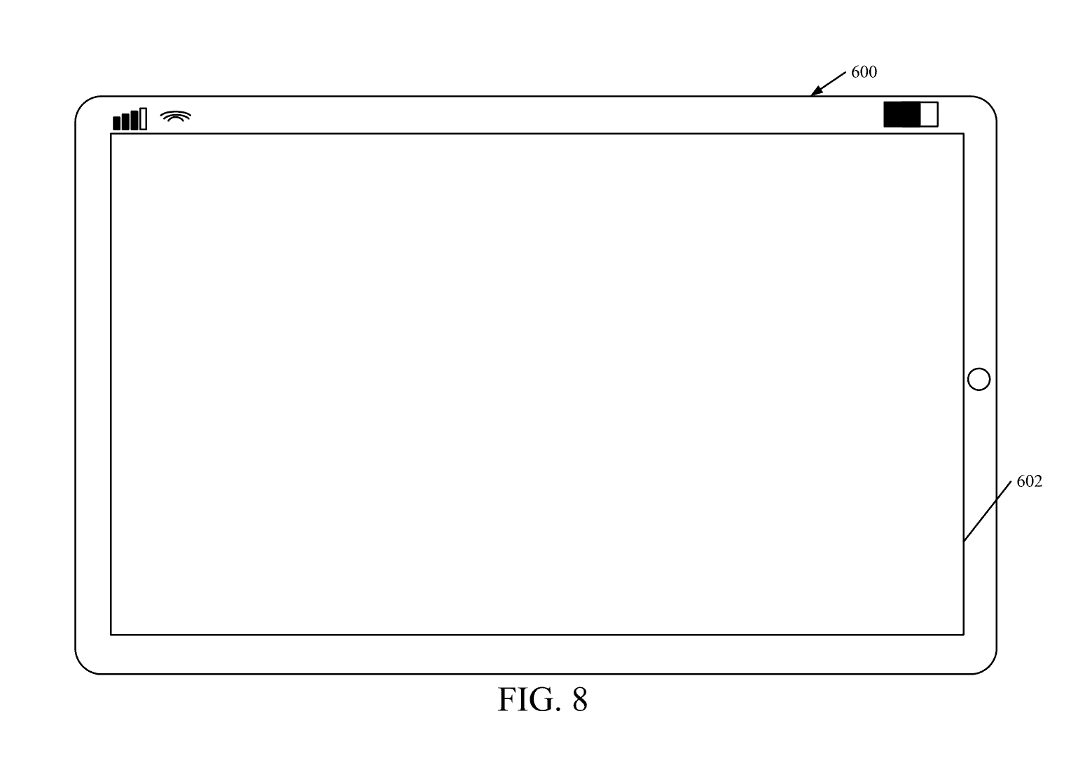

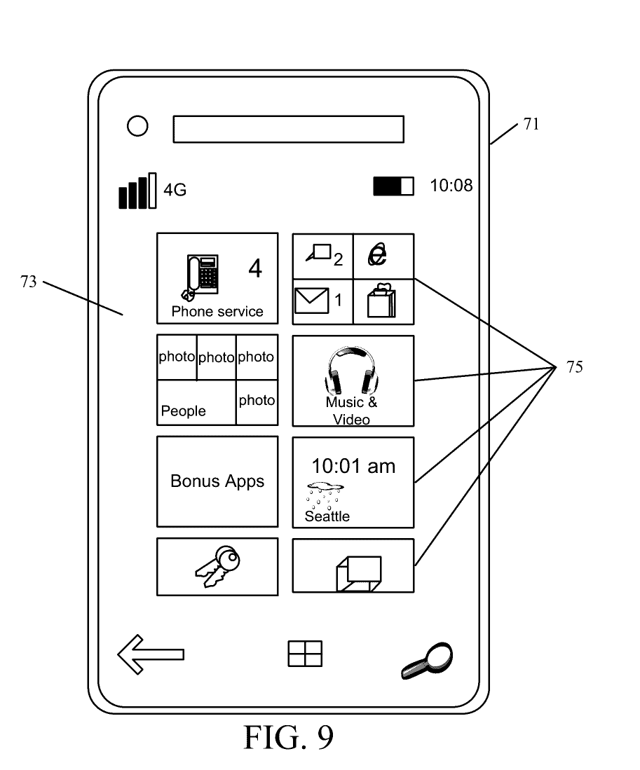

FIG. 7 is a simplified block diagram of one illustrative embodiment of a handheld or mobile computing device that can be used as a user's or client's hand held device 16, in which the present system (or parts of it) can be deployed. FIGS. 8-9 are examples of handheld or mobile devices.

FIG. 7 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one example in which device 16 is a tablet computer 600. In FIG. 8, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. Device 16 can be, a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some examples the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 9 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

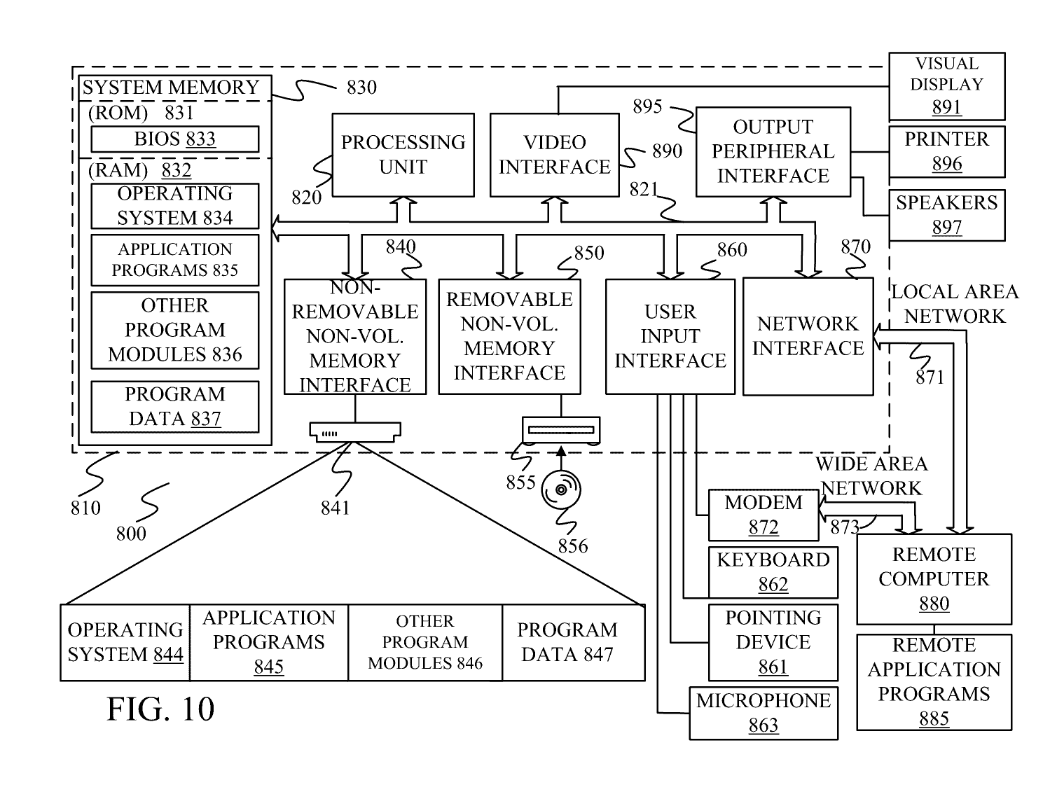

FIG. 10 is one example of a computing environment in which architecture 100, or parts of it, (for example) can be deployed. With reference to FIG. 10, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a user interface component;

a visualization control component that controls the user interface component to display a time view control user interface display with time view configuration user input mechanisms and that detects user actuation of the time view configuration user input mechanisms to define a time view configuration; and

a visualization generator component that extracts and aggregates data and that generates a time view display of the aggregated data based on the time view configuration and that controls the user interface component to display the time view display according to the time view configuration.

Example 2 is the computing system of any or all previous examples wherein the visualization control component comprises:

a time period component that generates a plurality of different time period configuration user input mechanisms on the time view control user interface display, each corresponding to a time period and that detects user actuation of at least a given time period configuration user input mechanism.

Example 3 is the computing system of any or all previous examples wherein the visualization generator component comprises:

a data extractor that, in response to detecting a user visualization request, extracts data corresponding to a given time period corresponding to the given time period configuration user input mechanism; and

an aggregation component that aggregates the extracted data over the given time.

Example 4 is the computing system of any or all previous examples wherein the visualization generator component comprises:

a display layout generator that generates a display layout based on the time view configuration; and

a view generator that controls the user interface component to display the aggregated data in the display layout.

Example 5 is the computing system of any or all previous examples wherein the visualization control component controls the user interface component to display the time view control user interface display with a relative time period user input mechanism, indicative of a relative time period offset from the given time period in a first direction, and further comprising:

a relative time period correlation component that detects user actuation of the relative time period user input mechanism and, in response, identifies the relative time period.

Example 6 is the computing system of any or all previous examples wherein the data extractor extracts data corresponding to the relative time period and wherein the aggregation component aggregates the extracted data over the relative time period.

Example 7 is the computing system of any or all previous examples wherein the display layout generator generates the display layout based on the relative time period, and wherein the view generator controls the user interface component to display the aggregated data in the display layout.

Example 8 is the computing system of any or all previous examples wherein the visualization control component comprises:

a custom period component that displays a custom time period user input mechanism, and detects user actuation of the custom time period user input mechanism to define a custom time period.

Example 9 is the computing system of any or all previous examples wherein the data extractor extracts data corresponding to the custom time period and wherein the aggregation component aggregates the extracted data over the custom time period.

Example 10 is the computing system of any or all previous examples wherein the display layout generator generates the display layout based on the custom time period, and wherein the view generator controls the user interface component to display the aggregated data in the display layout.

Example 11 is a computing system, comprising:

a user interface component;

a visualization control component that detects user actuation of a configuration request input and, in response, controls the user interface component to display a dimension view control user interface display with dimension view configuration user input mechanisms and that detects user actuation of the dimension view configuration user input mechanisms to define a dimension interval; and

a visualization generator component that extracts and aggregates data and that generates a dimension view display of the aggregated data based on the dimension interval and that controls the user interface component to display the dimension view display according to the dimension interval.

Example 12 is the computing system of any or all previous examples wherein the visualization generator component comprises:

a display layout generator that generates a display layout indicative of the dimension interval; and

a view generator that displays the aggregated data according to the display layout.

Example 13 is the computing system of any or all previous examples wherein the visualization control component detects user actuation of the dimension view configuration user input mechanisms to change the dimension interval wherein, in response, the visualization generator component automatically extracts and aggregates data corresponding to the changed dimension interval.

Example 14 is the computing system of any or all previous examples wherein the display layout generator automatically generates a changed display layout indicative of the changed dimension interval, and wherein the view generator displays the aggregated data according to the changed display layout.

Example 15 is a computer implemented method, comprising:

detecting user actuation of a configuration request input;

in response, controlling a user interface component to display a dimension view control user interface display with dimension view configuration user input mechanisms;

detecting user actuation of the dimension view configuration user input mechanisms to define a dimension interval;

extracting and aggregating data based on the dimension interval;

generating a dimension view display of the aggregated data based on the dimension interval; and

controlling the user interface component to display the dimension view display according to the dimension interval.

Example 16 is the computer implemented method of any or all previous examples wherein generating the dimension view display comprises:

generating a display layout indicative of the dimension interval; and

displaying the aggregated data according to the display layout.

Example 17 is the computer implemented method of any or all previous examples and further comprising:

detecting user actuation of the dimension view configuration user input mechanisms to change the dimension interval; and

in response, automatically extracting and aggregating data corresponding to the changed dimension interval.

Example 18 is the computer implemented method of any or all previous examples and further comprising:

automatically generating a changed display layout indicative of the changed dimension interval; and

displaying the aggregated data according to the changed display layout.

Example 19 is the computer implemented method of any or all previous examples wherein the dimension interval comprises a time interval and further comprising:

detecting user actuation of a relative time period user input mechanism, indicative of a relative time period offset from the time interval in a first direction;

automatically extracting data corresponding to the relative time period; and

aggregating the extracted data over the relative time period.

Example 20 is the computer implemented method of any or all previous examples and further comprising:

generating the display layout based on the relative time period; and

displaying the aggregated data in the display layout.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a user interface component;
a visualization control component that controls the user interface component to display a time view control user interface display with time view configuration user input mechanisms and that detects user actuation of the time view configuration user input mechanisms to define a time view configuration; and
a visualization generator component that extracts and aggregates data and that generates a time view display of the aggregated data based on the time view configuration and that controls the user interface component to display the time view display according to the time view configuration.

2. The computing system of claim 1 wherein the visualization control component comprises:
a time period component that generates a plurality of different time period configuration user input mechanisms on the time view control user interface display, each corresponding to a time period and that detects user actuation of at least a given time period configuration user input mechanism.

3. The computing system of claim 2 wherein the visualization generator component comprises:
a data extractor that, in response to detecting a user visualization request, extracts data corresponding to a given time period corresponding to the given time period configuration user input mechanism; and
an aggregation component that aggregates the extracted data over the given time.

4. The computing system of claim 3 wherein the visualization generator component comprises:
a display layout generator that generates a display layout based on the time view configuration; and
a view generator that controls the user interface component to display the aggregated data in the display layout.

5. The computing system of claim 4 wherein the visualization control component controls the user interface component to display the time view control user interface display with a relative time period user input mechanism, indicative of a relative time period offset from the given time period in a first direction, and further comprising:
a relative time period correlation component that detects user actuation of the relative time period user input mechanism and, in response, identifies the relative time period.

6. The computing system of claim 5 wherein the data extractor extracts data corresponding to the relative time period and wherein the aggregation component aggregates the extracted data over the relative time period.

7. The computing system of claim 6 wherein the display layout generator generates the display layout based on the relative time period, and wherein the view generator controls the user interface component to display the aggregated data in the display layout.

8. The computing system of claim 4 wherein the visualization control component comprises:
a custom period component that displays a custom time period user input mechanism, and detects user actuation of the custom time period user input mechanism to define a custom time period.

9. The computing system of claim 8 wherein the data extractor extracts data corresponding to the custom time period and wherein the aggregation component aggregates the extracted data over the custom time period.

10. The computing system of claim 9 wherein the display layout generator generates the display layout based on the custom time period, and wherein the view generator controls the user interface component to display the aggregated data in the display layout.

11. A computing system, comprising:
a user interface component;
a visualization control component that detects user actuation of a configuration request input and, in response, controls the user interface component to display a dimension view control user interface display with dimension view configuration user input mechanisms and that detects user actuation of the dimension view configuration user input mechanisms to define a dimension interval; and
a visualization generator component that extracts and aggregates data and that generates a dimension view display of the aggregated data based on the dimension interval and that controls the user interface component to display the dimension view display according to the dimension interval.

12. The computing system of claim 11 wherein the visualization generator component comprises:
a display layout generator that generates a display layout indicative of the dimension interval; and
a view generator that displays the aggregated data according to the display layout.

13. The computing system of claim 12 wherein the visualization control component detects user actuation of the dimension view configuration user input mechanisms to change the dimension interval wherein, in response, the visualization generator component automatically extracts and aggregates data corresponding to the changed dimension interval.

14. The computing system of claim 13 wherein the display layout generator automatically generates a changed display layout indicative of the changed dimension interval, and wherein the view generator displays the aggregated data according to the changed display layout.

15. A computer implemented method, comprising:
detecting user actuation of a configuration request input;
in response, controlling a user interface component to display a dimension view control user interface display with dimension view configuration user input mechanisms;
detecting user actuation of the dimension view configuration user input mechanisms to define a dimension interval;
extracting and aggregating data based on the dimension interval;
generating a dimension view display of the aggregated data based on the dimension interval; and
controlling the user interface component to display the dimension view display according to the dimension interval.

16. The computer implemented method of claim 15 wherein generating the dimension view display comprises:
generating a display layout indicative of the dimension interval; and
displaying the aggregated data according to the display layout.

17. The computer implemented method of claim 16 and further comprising:
detecting user actuation of the dimension view configuration user input mechanisms to change the dimension interval; and
in response, automatically extracting and aggregating data corresponding to the changed dimension interval.

18. The computer implemented method of claim 17 and further comprising:
automatically generating a changed display layout indicative of the changed dimension interval; and
displaying the aggregated data according to the changed display layout.

19. The computer implemented method of claim 16 wherein the dimension interval comprises a time interval and further comprising:
detecting user actuation of a relative time period user input mechanism, indicative of a relative time period offset from the time interval in a first direction;
automatically extracting data corresponding to the relative time period; and
aggregating the extracted data over the relative time period.

20. The computer implemented method of claim 19 and further comprising:
generating the display layout based on the relative time period; and
displaying the aggregated data in the display layout.
